(19) United States
(12) Patent Application Publication
(10) Pub. No.: US 2013/0346294 A1
(43) Pub. Date: Dec. 26, 2013

(54) RISK MANAGER OPTIMIZER

(71) Applicants: Patrick Faith, Pleasanton, CA (US); Kevin Siegel, Mountain View, CA (US); Mayrose Kragas, Foster City, CA (US)

(72) Inventors: Patrick Faith, Pleasanton, CA (US); Kevin Siegel, Mountain View, CA (US); Mayrose Kragas, Foster City, CA (US)

(21) Appl. No.: 13/842,145

(22) Filed: Mar. 15, 2013

Related U.S. Application Data
(60) Provisional application No. 61/613,940, filed on Mar. 21, 2012.

(51) Int. Cl. G06Q 20/40

(52) U.S. Cl. CPC G06Q 20/4016
USPC 705/39

(57) ABSTRACT

Embodiments of the invention broadly described, introduce systems and methods for automatically generating rules. One embodiment of the invention discloses a method for generating a candidate rule. The method comprises receiving transaction data comprising a plurality of fields, wherein each field is associated with one or more field values, constructing a rule graph, wherein vertices in the rule graph correspond to a plurality of the one or more field values, generating a tree, wherein generating the tree comprises selecting an edge from a set of edges connecting a vertex in the tree with a vertex not in the tree, and adding the edge to the tree if the edge has a maximum signal-to-noise value of all edges in the set of edges, and converting the tree into a candidate rule.

### CROSS-REFERENCES TO RELATED APPLICATIONS

The present application is a non-provisional application of and claims priority to U.S. Provisional Application No. 61/613,940, filed on Mar. 21, 2012 (Attorney Docket No.: 79900-835352(026700USP1)), the entire contents of which are herein incorporated by reference for all purposes.

### BACKGROUND

Fraud rules are rules that may be used to automatically detect fraudulent activity. For example, fraud rules may be used to determine if a payment transaction is fraudulent, or if a payment account has been compromised. Fraud rules may be evaluated at a payment account issuer, payment processing network, or merchant acquirer. If a fraudulent transaction is detected, it may be immediately rejected, flagged for manual approval, or approved and logged for later review.

Fraud rules are widely utilized, but defining fraud rules may require significant human expertise and effort. For example, a security expert may need to identify a pattern of fraud based on certain characteristics and manually program a rule for identifying the pattern in transactions. In the time taken to perform these actions, a new pattern of fraud may emerge. In addition, a security expert is limited in the scope of data he or she can manually examine out of millions or billions of transaction records. The security expert may use statistical sampling, but in the presence of sparse data some information may be lost during the sampling process.

Embodiments of the invention address these and other problems.

### SUMMARY

Embodiments of the invention broadly described, introduce systems and methods for automatically generating rules.

One embodiment of the invention discloses a computer-implemented method for selecting a field combination. The method comprises receiving, by a processor, transaction data comprising a plurality of fields, wherein each field is associated with one or more field values, identifying one or more field combinations using the fields, determining a field combination signal-to-noise value for one of the identified field combinations, wherein the field combination signal-to-noise value is determined using one or more field value combination signal-to-noise values, and selecting a field combination, wherein the field combination is used to generate a rule.

One embodiment of the invention discloses a server computer. The server computer comprises a processor and a non-transitory computer-readable storage medium, comprising code executable by the processor for implementing a method comprising receiving, by the processor, transaction data comprising a plurality of fields, wherein each field is associated with one or more field values, identifying one or more field combinations using the fields, determining a field combination signal-to-noise value for one of the identified field combinations, wherein the field combination signal-to-noise value is determined using one or more field value combination signal-to-noise values, and selecting a field combination, wherein the field combination is used to generate a rule.

One embodiment of the invention discloses a computer-implemented method for generating a candidate rule. The method comprises receiving, by a processor, transaction data comprising a plurality of fields, wherein each field is associated with one or more field values, constructing a rule graph, wherein vertices in the rule graph correspond to a plurality of the one or more field values, generating a tree, wherein generating the tree comprises selecting an edge from a set of edges connecting a vertex in the tree with a vertex not in the tree, and adding the edge to the tree if the edge is associated with a maximum signal-to-noise value of all edges in the set of edges, and converting the tree into a candidate rule.

One embodiment of the invention discloses a server computer. The server computer comprises a processor and a non-transitory computer-readable storage medium, comprising code executable by the processor for implementing a method comprising receiving, by the processor, transaction data comprising a plurality of fields, wherein each field is associated with one or more field values, constructing a rule graph, wherein vertices in the rule graph correspond to a plurality of the one or more field values, generating a tree, wherein generating the tree comprises selecting an edge from a set of edges connecting a vertex in the tree with a vertex not in the tree, and adding the edge to the tree if the edge is associated with a maximum signal-to-noise value of all edges in the set of edges, and converting the tree into a candidate rule.

A further embodiment of the invention discloses a computer-implemented method. The method comprises receiving, by a processor, transaction data comprising a plurality of fields, wherein each field is associated with one or more field values, identifying one or more field combinations using the fields, determining a field combination signal-to-noise value for one of the identified field combinations, wherein the field combination signal-to-noise value is determined using one or more field value combination signal-to-noise values, selecting a field combination, constructing a rule graph, wherein vertices in the rule graph correspond to a plurality of the one or more field values associated with the selected field combination, generating a tree, wherein generating the tree comprises selecting an edge from a set of edges connecting a vertex in the tree with a vertex not in the tree, and adding the edge to the tree if the edge has a maximum signal-to-noise value of all edges in the set of edges, and converting the tree into a candidate rule.

A further embodiment of the invention discloses a server computer. The server computer comprises a processor and a non-transitory computer-readable storage medium, comprising code executable by the processor for implementing a method comprising receiving, by the processor, transaction data comprising a plurality of fields, wherein each field is associated with one or more field values, identifying one or more field combinations using the fields, determining a field combination signal-to-noise value for one of the identified field combinations, wherein the field combination signal-to-noise value is determined using one or more field value combination signal-to-noise values, selecting a field combination, constructing a rule graph, wherein vertices in the rule graph correspond to a plurality of the one or more field values associated with the selected field combination, generating a tree, wherein generating the tree comprises selecting an edge from a set of edges connecting a vertex in the tree with a vertex not in the tree, and adding the edge to the tree if the edge has a maximum signal-to-noise value of all edges in the set of edges, and converting the tree into a candidate rule.

Further details regarding embodiments of the invention can be found in the Detailed Description and the Figures.

### BRIEF DESCRIPTION OF THE DRAWINGS

FIG. 1 shows a system according to an embodiment of the invention.

FIG. 2 shows an exemplary payment processing network that may be used in embodiments of the invention.

FIG. 3 illustrates an exemplary transaction database according to some embodiments of the invention.

FIG. 4 illustrates a method performed at a rule generation computer for generating fraud rules.

FIG. 5 shows an example of transaction data according to some embodiments of the invention.

FIG. 6 shows an example of transaction data wherein fraudulent transactions have been identified.

FIG. 7 shows an example of fraudulent and non-fraudulent datasets according to some embodiments of the invention.

FIG. 8 shows an example of aggregate metrics according to one embodiment of the invention.

FIG. 9 shows an example of 2-field combinations according to one embodiment of the invention.

FIG. 10 shows a method performed at a rule generation computer 210 for selecting field combinations.

FIG. 11 illustrates exemplary field value combinations for one embodiment of the invention.

FIG. 12 shows an exemplary table comprising field combination SNVs for one embodiment of the invention.

FIG. 13 shows a method of constructing a fraud rule graph for some embodiments of the invention.

FIG. 14 shows an exemplary fraud rule graph with vertices and edges populated in accordance with the method shown in FIG. 13.

FIG. 15 shows a method for generating a candidate fraud rule using a fraud rule tree according to some embodiments of the invention.

FIG. 16 shows an exemplary fraud tree in one embodiment of the invention.

FIG. 17 shows an exemplary fraud tree in one embodiment of the invention.

FIG. 18 shows an exemplary fraud tree and candidate fraud rule in one embodiment of the invention.

FIG. 19 shows a method for determining ranking scores for candidate fraud rules.

FIG. 20 shows exemplary candidate fraud rule SNVs, normalized fraud scores, and corresponding ranking scores.

FIG. 21 shows a method for filtering candidate fraud rules using fraud rule parameters to generate final fraud rules according to one embodiment of the invention.

FIG. 22 illustrates an exemplary set of final fraud rules in one embodiment of the invention.

FIG. 23 shows a method of evaluating fraud rules according to one embodiment of the invention.

FIG. 24 shows an exemplary user interface displaying generated fraud rules.

FIG. 25 shows an exemplary user interface displaying statistics regarding the generated fraud rules.

FIG. 26 shows an exemplary payment device in the form of a card.

FIG. 27 is a high level block diagram of a computer system that may be used to implement any of the entities or components described for embodiments of the invention.

### DETAILED DESCRIPTION

Prior to discussing embodiments of the invention, description of some terms may be helpful in understanding embodiments of the invention.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

An “access device” may include any suitable device for communicating with merchant and for interacting with a portable consumer device. An access device can be in any suitable location such as at the same location as a merchant. An access device may be in any suitable form. Some examples of access devices include POS terminals, cellular phones, PDAs, personal computers (PCs), tablet PCs, hand-held specialized readers, set-top boxes, electronic cash registers (ECRB), automated teller machines (ATMs), virtual cash registers (VCRs), kiosks, security systems, access systems, Websites, and the like. Typically, an access device may use any suitable contact or contactless mode of operation to electronically transmit or receive data from a portable consumer device.

The term “field” may include any property or characteristic that may take a plurality of values. In various embodiments of the invention, a field may correspond to a property or characteristic of a payment transaction.

A “field value” may be any suitable value for a field. One example of a field and associated field value may be: “card present/not present”, wherein the field value indicates whether the transaction was a “Card Present” transaction (i.e., a transaction evidenced by a physical card swipe or signature), or a “Card Not Present” transaction (i.e., any transaction which is not “Card Present”, such as those made online). Another example may be: “merchant category”, wherein the field value indicates the category of a merchant. Examples of merchant categories may include “Food”, “Retail”, and “Gas”.

A field value may contain alphabetic characters, numerals, symbols, or any combination thereof. A field value may be stored in a computer system as an integer, floating point number, string, object, or in any other suitable format. Examples of formats to store a plurality of field values may include XML, JSON, and serialized objects. In some embodiments, field values may also comprise non-printable characters.

In some embodiments of the invention, field values may be discretized. For example, transaction data may express an amount for the transaction in dollars and cents. However, the “Transaction Amount” field may be discretized, so that the field value may either be “less than $100”, or “greater than or equal to $100”. Thus, the corresponding “Transaction Amount” field for transactions may be assigned using the transaction amounts as one of the two field values.

A “signal-to-noise value” (SNV) may include a value proportional to the ratio of fraudulent transactions to non-fraudulent transactions. In some embodiments of the invention, a signal-to-noise value may also be proportional to the frequency or relative frequency of the transactions. A SNV may be calculated by determining a total number of fraudulent transactions and a total number of non-fraudulent transactions. In some embodiments, the SNV may follow the formula: SNV=((# of fraudulent transactions)/(# of non-fraudulent transactions))×(# of fraudulent transactions+# of non-fraudulent transactions). In other embodiments, the SNV may follow a different formula. In some embodiments of the invention, various SNV values may be computed differently. For example, in some embodiments, a field value SNV, field combination SNV, fraud rule tree SNV, and candidate fraud rule SNV may be computed using different formulae. In some embodiments, a SNV may also include any value proportional to the ratio of desirable occurrences to undesirable occurrences and/or proportional to the number of desirable and undesirable occurrences.

A “field value signal-to-noise value” (field value SNV) may include the SNV of transactions with a specific field value. For example, in some embodiments, a field value SNV for transactions having a “Merchant Category” field value of “Retail” may be calculated using all transactions having the “Merchant Category” field value of “Retail”. A “field signal-to-noise value” (field SNV) may include a combination of field value SNVs for all field values associated with the field. For example, the field SNV for the “Merchant Category” field may be calculated by combining the field value SNVs for “Food”, “Gas”, and “Retail”. If there are 5 non-fraudulent transactions having the field value “Gas” and 2 fraudulent transactions having the field value “Gas”, then in one embodiment, the SNV=(2/5)×(2 +5)=2.8.

A “field combination” may include a selection of fields from a plurality of fields. For example, in one embodiment, the plurality of fields may be “Card Present/Not Present”, “Merchant Category”, “Transaction Amount”, and “Transaction Velocity”. One example field combination of these fields would be the selection “Card Present/Not Present” and “Transaction Amount”. Another example field combination would be “Merchant Category” and “Transaction Velocity”. In total, for the given example, there would be 4C2, or 4!/(2!×2!)=6 total two-field combinations. In general, the number of K-field combinations of N total fields, where K N, may be expressed using the formula N!/(K!×(N−K)!), where the “!” operand indicates the factorial operation.

A “field value combination” may include a selection of field values for each field in a field combination. For example, for the field combination, “Card Present/Not Present” and “Transaction Amount”, one field value combination may be “Card Not Present”, and “Less than $100”. In another example, for the field combination, “Merchant Category”, “Transaction Amount”, and “Transaction Velocity”, one field value combination may be “Gas”, “Less than and $100”, and “High”. In general, the number of field value combinations for a field combination is the product of the number of different values each field can take. In the first example, of the field combination, “Card Present/Not Present” and “Transaction Amount”, there would be 2×2=4 total field value combinations, because “Card Present/Not Present” may take two different values, and “Transaction Amount” may take two different values.

A “field value combination signal-to-noise value” (field value combination SNV) may include a signal-to-noise value for transactions associated with a field value combination. In some embodiments, all transactions with field values having the values in the field value combination may be used to calculate the field value combination SNV. Specifically, in one embodiment, the totals of fraudulent transactions and non-fraudulent transactions with the values in the field value combination are determined. These totals are then used to calculate a field value SNV.

In one example, the field combination may be “Card Present/Not Present” and “Transaction Amount”, and the field value combination may be “Card Not Present”, and “Less than $100”. There may be 10 non-fraudulent transactions with the field value combination and 2 fraudulent transactions with the field value combination. Accordingly, in one embodiment, the field value combination SNV may be (2/10)×(2+10)=2.4.

A “field combination signal-to-noise value” (field combination SNV) may include a signal-to-noise value for a field combination. In some embodiments of the invention, the field combination SNV may be calculated by combining the field value SNVs associated with the field. For example, in some embodiments, the field SNV may be a sum of all associated field value SNVs.

In one example, a field combination may be “Card Present/Not Present” and “Transaction Amount”. Field value SNVs for the field combination may be 8.5 for “Card Present” and “Less than $100”, 12.6 for “Card Present” and “Greater than or equal to $100”, 14 for “Card Not Present” and “Less than $100”, and 18 for “Card Not Present” and “Greater than or equal to $100”. Accordingly, in one embodiment of the invention, the Field SNV for “Card Present/Not Present” and “Transaction Amount” may be 8.5+12.6+14+18=53.1.

A “fraud rule graph” refers to a graph constructed using one or more fields. The vertices in the fraud rule graph may represent field values. In some embodiments, each vertex in the fraud rule graph may be connected to every other vertex in the fraud rule graph. In such embodiments, the fraud rule graph may be a complete graph.

The fraud rule graph may be used to construct a “fraud rule tree” which spans one or more of the vertices in the fraud rule graph. A fraud rule tree may be converted to a “candidate fraud rule”. Each edge in the fraud rule tree represents a logical conjunction or disjunction of the field value in a candidate fraud rule corresponding to the fraud rule tree. For example, in some embodiments, if a fraud rule tree contained a single edge connecting a vertex representing “Card Present” to a vertex representing “Less than $100”, the corresponding candidate fraud rule would trigger on Card Present transactions with a transaction amount less than $100. If the fraud rule tree was expanded to also contain an edge connecting the vertex representing “Card Present” with a vertex representing “greater than or equal to $100”, then the corresponding candidate fraud rule would trigger on Card Present transactions of any kind (either less than, or greater than or equal to $100).

The terms “fraud rule tree signal-to-noise value” (fraud rule tree SNV) and “candidate fraud rule signal-to-noise value” (candidate fraud rule SNV) may both refer to a signal-to-noise value associated with a fraud rule tree and its corresponding candidate fraud rule. The fraud rule tree SNV may be calculated using transactions which satisfy a candidate fraud rule corresponding to the fraud rule tree. In one example, a fraud rule tree may contain an edge connecting a vertex representing “Card Present” with a vertex representing a merchant category of “Food”, and a second edge connecting the vertex representing a merchant category of “Food” with a vertex representing a merchant category of “Retail”. In some embodiments, a corresponding candidate fraud rule would trigger on Card Present transactions at either Retail or Food merchant categories. A corresponding fraud rule tree SNV may be calculated by calculating the SNV for transactions satisfying the candidate rule.

A “normalized fraud score” may include a fraud score between 0 and 1 indicating the likelihood that a transaction is associated with fraud. In some embodiments, a normalized fraud score of 0 may represent the highest likelihood of fraud. In other embodiments, a normalized fraud score 1 may represent the highest likelihood. In some embodiments, a normalized fraud score may be calculated for each transaction and combined to generate a normalized fraud score for multiple transactions. In other embodiments, a normalized fraud score may be calculated for multiple transactions.

A “ranking score” may include a fraud score resulting from the combination of a candidate fraud rule SNV with a normalized fraud score. In some embodiments, the ranking score may be a product of the candidate fraud rule SNV and the normalized fraud score.

The term “fraud rule parameters” may be used to refer to any requirements, parameters, or specification relating to desirable fraud rules. In some embodiments, an issuer may send a document comprising fraud rule parameters to indicate preferred characteristics of generated fraud rules. For example, in one embodiment, an issuer may specify that fraud rules should not be generated for transactions over $100, since such transactions are to be handled through human review. This parameter may be used to filter candidate fraud rules triggered only by transactions over $100, so that such fraud rules may not be sent to the issuer. In another example, a fraud rule parameter may specify that the fraud rules must be time-invariant (i.e., that they have a high fraud rule SNR for any selected time period of transactions), or that the fraud rules must be easily readable (i.e., that they should have few enough terms for a human to quickly read and understand them). In some embodiments, the payment processing network, issuer processor, or other party may also define fraud rule parameters. The fraud rule parameters may be encoded in any suitable format. For example, the fraud rule parameters may be expressed in a markup language, such as XML, an object notation such as JSON, or a declarative language such as Prolog.

A “fraud rule output file” may be used to refer to any file comprising one or more fraud rules. The fraud rules may be encoded in any human-readable or machine-readable format. In some embodiments of the invention, the fraud rule output file may be used to integrate the fraud rules into a fraud detection engine or fraud manager user interface. The fraud rule output file may be stored in any suitable format, including a markup language, such as XML, an object notation such as JSON, or a declarative language such as Prolog.

It should be noted that the although the terms above may include a meaning relating to fraudulent transactions, embodiments of the invention are not so limited. For example, embodiments of the invention may generally relate to “rule graphs”, “rule trees”, “rule parameters”, “rule output files”, normalized scores”, “candidate rules”, and “finalized rules”. It is noted that the methods disclosed for embodiments of the invention may generally be applied in domains other than fraud rule generation.

Embodiments of the invention provide for many technical advantages. For example, embodiments of the invention provide an efficient method of generating fraud rules. Selecting a field combination from a plurality of fields allows the method to choose only the fields that predict fraud well. This enables subsequent operations to be performed more efficiently. For example, generating a fraud rule graph for a field combination rather than all fields may significantly improve efficiency, and the selection of high SNV field combinations allows the most predictive fields to be retained, which maintains the efficacy of the generated fraud rules.

Furthermore, the process of generating a fraud rule graph and then determining a tree spanning one or more vertices allows for a more efficient generation of candidate fraud rules. In a “brute force” approach, the number of operations required to determine fraud rules generated from N field values is proportional to 2″. In contrast, determining a tree spanning one or more vertices is significantly more efficient, at least because each iteration of the method may only consider the subset of edges which connect vertices in the tree with vertices outside the tree.

Embodiments of the invention provide the further technical advantage of enabling parallel execution of the disclosed methods. In some embodiments, the methods disclosed may be divided into separate map and reduce phases. The map phase may be used to take a key-value pair and transform it from one domain to another domain. The reduce phase may be used to combine some or all values sharing the same key into a single value in the same domain. Dividing a method into map and reduce phases allows the method to be executed in parallel using a large cluster of computers, enabling the method to scale to very large amounts of data. In some embodiments of the invention, the map and reduce phases may be performed using the MapReduce™ model or the Apache Hadoop™ model.

Embodiments provide the further advantage of operating on a full population dataset. Due in part to the sparse nature of fraud (which generally constitutes a low percentage of total transactions), techniques which sample transaction data may cause certain patterns to be lost. For instance, patterns may not be present in the sample or beneath the threshold for statistical significance. In contrast, embodiments of the invention may operate on a full population of data, which enables patterns to be identified even if such patterns are only present in a low percentage of the dataset.

Embodiments provide the further advantage of providing a method that can quickly adjust to changes in fraud patterns. Since embodiments of the invention may generate fraud rules automatically and with minimal human oversight, embodiments of the invention may be used to generate fraud rules at a frequent interval, such as weekly or daily. This may lead to more effective fraud rules, because the fraud rules may be generated to be reflective of new trends or fraud patterns.

The above examples highlight only a few of the advantages of using a multi-purpose device to provide membership and payment attributes.

I. Exemplary Systems

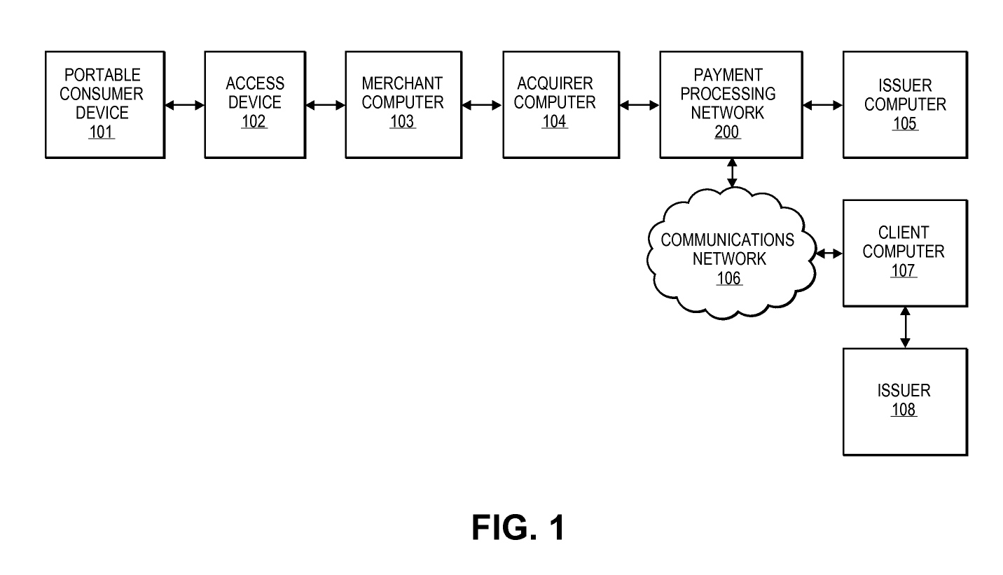

FIG. 1 shows a system according to an embodiment of the invention. The system comprises consumer (not shown) who may operate a portable consumer device 101. The consumer may use portable device 101 to conduct purchase transactions at an access device 102 connected to a merchant computer 103. Merchant computer 103 may be connected to acquirer computer 104. Acquirer computer 104 may be connected to issuer computer 105 via payment processing network 200. Issuer 108 may operate client computer 107 to communicate with payment processing network 200 via communications network 104. Communications network 106 may comprise any wired or wireless communication media, and may allow for communication between a client computer 102 and a payment processing network 200.

In some embodiments of the invention, an issuer 108 may use a client computer 107 to communicate with payment processing network 200. Issuer 108 may use client computer 107 to view and select fraud rules generated by payment processing network 200, or may use client computer 107 to define fraud rules and send them to payment processing network 200. In some embodiments, issuer 108 may also use client computer 107 to define fraud rule parameters which may indicate to the payment processing network various filters to be applied to candidate fraud rules.

As used herein, an “issuer” may typically refer to a business entity (e.g., a bank) that maintains financial accounts for a consumer and often issues a portable consumer device 101 such as a credit or debit card to the consumer. A “merchant” is typically an entity that engages in transactions and can sell goods or services. An “acquirer” is typically a business entity (e.g., a commercial bank) that has a business relationship with a particular merchant or other entity. Some entities can perform both issuer and acquirer functions. Some embodiments may encompass such single entity issuer-acquirers. Each of the entities (e.g., merchant computer 103, acquirer computer 104, payment processing network 200, issuer 108, and issuer computer 105) may comprise one or more computer apparatuses to enable communications through the communications network 106, or to perform one or more of the functions described herein.

The payment processing network 200 may include data processing subsystems, networks, and operations used to support and deliver certificate authority services, authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 200 may include one or more server computers. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 200 may use any suitable wired or wireless network, including the Internet. In some embodiments, rule generation computer 210 may be located at the payment processing network 200, or the payment processing network 200 may provide data to the rule generation computer 210.

In a typical purchase transaction, the consumer purchases a good or service at merchant 103 using a portable consumer device 101. The user's portable consumer device 101 can interact with an access device 102 at a merchant associated with merchant computer 103. For example, the consumer may tap the portable consumer device 101 against an NFC reader in the access device 102. Alternately, the consumer may indicate payment details to the merchant electronically, such as in an online transaction.

An authorization request message is generated by the access device 102 and is then forwarded to the acquirer computer 104. After receiving the authorization request message, the authorization request message is then sent to the payment processing network 200. The payment processing network 200 then forwards the authorization request message to the corresponding issuer computer 105 associated with the issuer 108 of the portable consumer device 101.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

After the issuer computer 105 receives the authorization request message, the issuer computer 105 sends an authorization response message back to the payment processing network 200 to indicate whether or not the current transaction is authorized (or not authorized). The payment processing network 200 then forwards the authorization response message back to the acquirer 104. The acquirer 104 then sends the response message back to the merchant computer 103. In some embodiments, such as when a fraud rule is trigger at payment processing network 200, payment processing network 200 may decline a transaction previously authorized by issuer computer 105.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

After the merchant computer 103 receives the authorization response message, the access device at the merchant computer 103 may then provide the authorization response message for the consumer. The response message may be displayed by the contactless access device, or may be printed out on a receipt. Alternately, if the transaction is an online transaction, the merchant may provide a web page or other indication of the authorization response message.

At the end of the day, a normal clearing and settlement process can be conducted by the payment processing network 200. A clearing process is a process of exchanging financial details between and acquirer and an issuer to facilitate posting to a user's payment account and reconciliation of the user's settlement position.

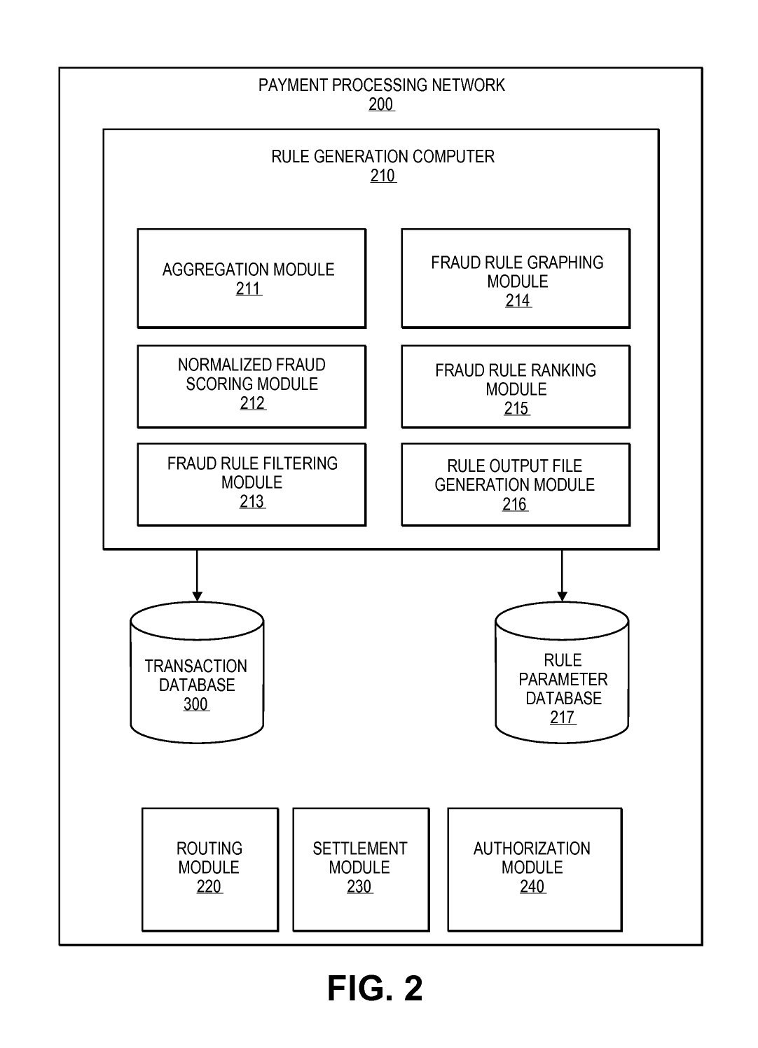

FIG. 2 shows an exemplary payment processing network that may be used in embodiments of the invention. The payment processing network 200 comprises a rule generation computer 210, a transaction database 300, a rule parameter database 217, a routing module 220, a settlement module 230, and an authorization module 240.

Rule generation computer 210 may be a server computer or other computer responsible for generating fraud rules. Rule generation computer 210 may comprise an aggregation module 211, normalized fraud scoring module 212, fraud rule filtering module 213, fraud rule graphing module 214, fraud rule ranking module 215, and rule output module 216. Aggregation module 211 may be used to aggregate metrics on transaction data. For example, aggregation module 211 may be used to calculate a number of fraudulent and non-fraudulent transactions satisfying certain critera (e.g., having a specific field value or set of field values). Normalized fraud scoring module 212 may be used to calculate a normalized fraud score for one or more transactions. The normalized fraud score may provide an indication of the likelihood of fraud based on the transactions. Fraud rule filtering module 213 may be used to filter fraud rules using fraud rule parameters. Fraud rule graphing module 214 may be used to generate and operate on data structures representing fraud rule graphs. Rule output file generation module 216 may be used to generate output files comprising fraud rules.

Rule generation computer 210 may be operatively coupled to transaction database 300 and rule parameter database 217.

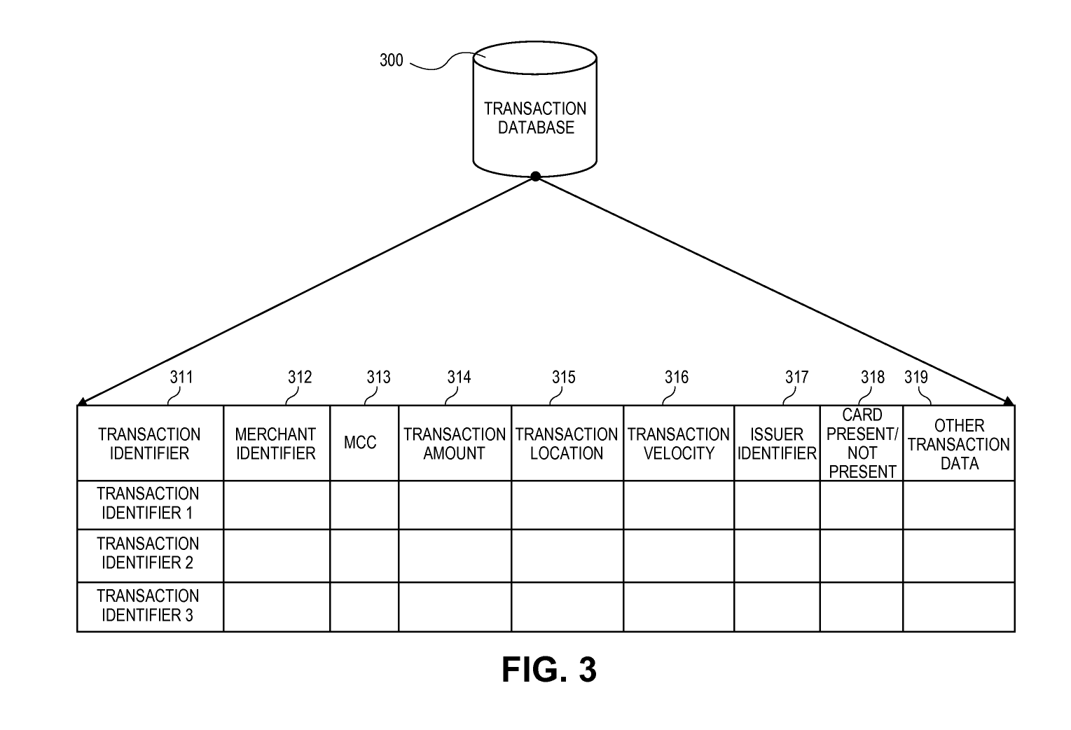

Transaction database 300 may be used to store transaction data. An exemplary embodiment of transaction database 300 is shown in FIG. 3.

Rule parameter database 217 may comprise one or more fraud rule parameters. Typically, rule parameter database 217 may receive fraud rule parameters defined by issuer 108 and sent from issuer computer 105 or client computer 107. The fraud rule parameters may be stored in any suitable database, such as a relational database or object-oriented database.

FIG. 3 illustrates an exemplary transaction database according to some embodiments of the invention. The transaction database 300 may have a plurality of fields, including a transaction identifier 311, merchant identifier 312, merchant category code (MCC) 313, transaction amount 314, transaction location 315, transaction velocity 316, issuer identifier 317, card present/not present 318, or other transaction data 319.

Transaction identifier 311 may be any identifier suitable for identifying a transaction. For example, in some embodiments, the transaction identifier 311 may be a Cardholder Authentication Verification Value (CAW). Merchant identifier 312 may be any identifier suitable to identify a merchant, such as a merchant associated with merchant computer 105. Issuer identifier 317 may be any identifier suitable to identify an issuer 108. In various embodiments, issuer identifier 317 may be a bank identification number (BIN), or ACH routing number. Transaction identifier 311, merchant identifier 313, and issuer identifier 317 may be assigned by any suitable party, such as a merchant computer 103, acquirer computer 104, payment processing network 200, or issuer computer 105.

Merchant category code 313 may be used to indicate a code describing the type of goods or services sold at the merchant at which the transaction was conducted. In some embodiments of the invention, the merchant category code may be a four-digit number.

Transaction amount 314 may represent the amount paid for the transaction. For example, an item was purchased for $8.96 including all taxes and gratuities, transaction amount 314 may be $8.96.

Transaction location 315 may represent the location at which the transaction was conducted. In various embodiments, the transaction location may be represented by a ZIP® code, an address, or a latitude-longitude pair.

Transaction velocity 316 may represent the frequency of transactions during the time at which a transaction was conducted.

Card Present/Not Present 318 may be used to indicate whether the transaction was a Card Present transaction or a Card Not Present transaction. Typically, a Card Present transaction may be a transaction conducted with a physical card swipe and/or cardholder signature. Typically, a Card Not Present transaction may be a transaction conducted using an entered credit card number, such as during a transaction conducted online or by telephone.

Other transaction data 319 may include any other data associated with the transaction. In some embodiments, other transaction data 319 may include derived fields or fields determined by multiple transactions. For example, other transaction data 319 may include a previous fraudulent transaction field indicating that a previous transaction by the consumer that performed the transaction was marked as fraudulent. In some embodiments, other transaction data 319 may also include aggregates generated from multiple other transaction fields. For example, an issuer identifier 317 and a transaction location 315 for a transaction may be used to construct a field representing whether the transaction was conducted in a foreign country to the issuer 108.

In some embodiments of the invention, the fields 311-319 described may be arbitrarily discretized before being stored in the transaction data base or upon retrieval from the transaction database. For example, in some embodiments, the transaction amount may be discretized so that it falls into one of two values: a value for transactions with an amount less than $100, and a value for transactions greater than or equal to $100. In another example, the MCC may be discretized, so that instead of a four-digit MCC (with up to 10000 possible values), the merchant category may be discretized into major categories, such as “Food”, “Retail”, or “Gas”.

II. Exemplary Fraud Rule Generation Methods

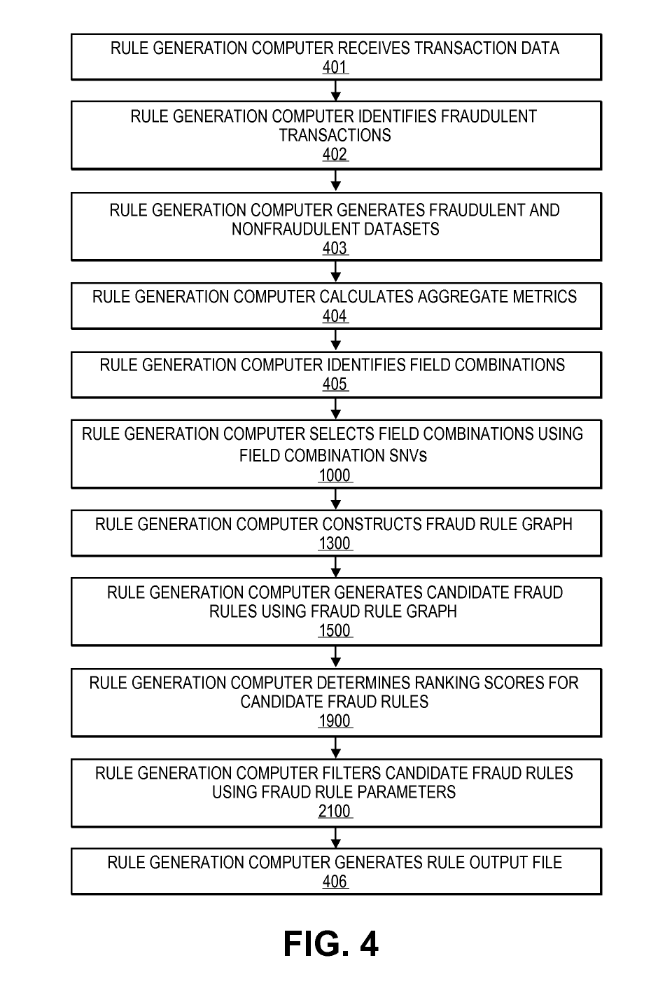

FIG. 4 illustrates a method performed at a rule generation computer for generating fraud rules. The method shown may be performed once or periodically to generate new fraud rules.

At step 401, rule generation computer 210 receives transaction data. In some embodiments, the transaction data may be received from transaction database 300. In other embodiments, the transaction data may be received from the payment processing network 200, an issuer computer 105, or any other suitable source. The transaction data may include a plurality of fields. Some examples of fields are explained above for FIG. 3.

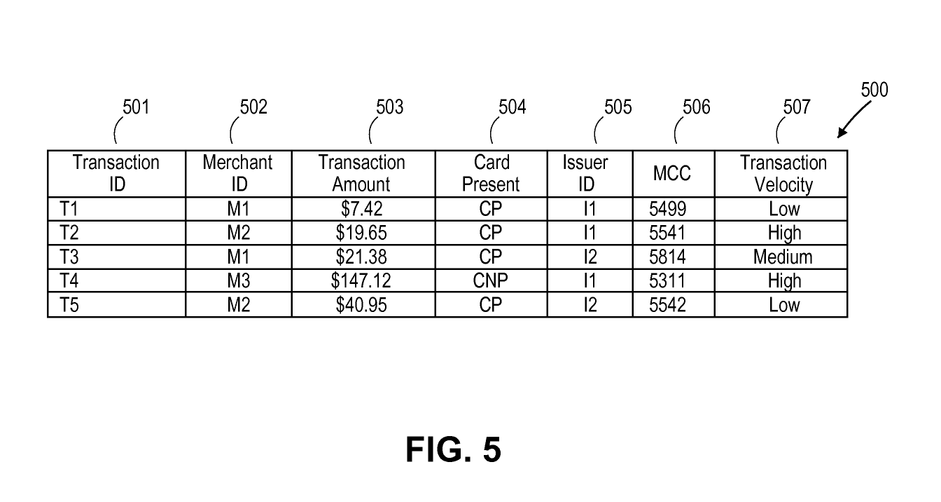

FIG. 5 shows an example of transaction data according to some embodiments of the invention. The transaction data is stored in a table 500. Table 500 comprises multiple fields, such as Transaction ID 501, Merchant ID 502, Transaction Amount 503, Card Present 504, Issuer ID 505, MCC 506, and Transaction Velocity 507. In some embodiments, the transaction data may comprise all fields stored in the transaction database. In other embodiments, the transaction data may comprise a subset of the fields stored in the transaction database.

Returning to FIG. 4, at step 402, rule generation computer 210 identifies fraudulent transactions. Rule generation computer 210 may identify transactions as fraudulent by any suitable means. In some embodiments, a transaction may be marked as fraudulent if a consumer reports the transaction as fraudulent to an issuer 108. In some embodiments, the issuer 108 may mark a transaction as fraudulent if the issuer 108 determines that the likelihood of fraud is very high. In some embodiments, the issuer 108 may mark all transactions occurring after a portable consumer device 101 was lost or stolen as fraudulent.

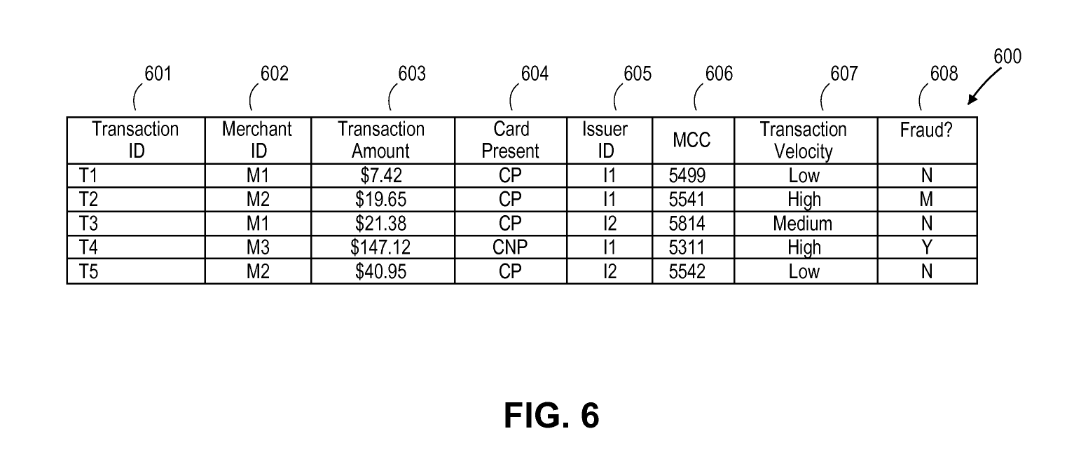

FIG. 6 shows an example of transaction data wherein fraudulent transactions have been identified. In FIG. 6, table 600 comprises fields 601-607. Fields 601-607 correspond to fields 501-507 in table 500. However, a new column 608 has been added to the table to indicate whether a transaction is fraudulent or non-fraudulent.

Returning to FIG. 4, at step 403, rule generation computer 210 generates fraudulent and non-fraudulent datasets. In some embodiments of the invention, the generation of fraudulent and non-fraudulent datasets may involve separately storing fraudulent and non-fraudulent transaction data. For example, in embodiments where the datasets are stored in a relational database, the datasets may be stored in different tables. The fraudulent and non-fraudulent datasets may also omit fields which are determined to be too transaction-specific. For example, the transaction, customer, merchant, or issuer identifier associated with the transaction may be omitted because such fields may not be predictive of fraud. In addition, rule generation computer 210 may discretize transaction data when storing the datasets. In some embodiments, fields with a high cardinality (i.e., a high number of possible field values for the field) may be reduced to a relatively small set of possible values.

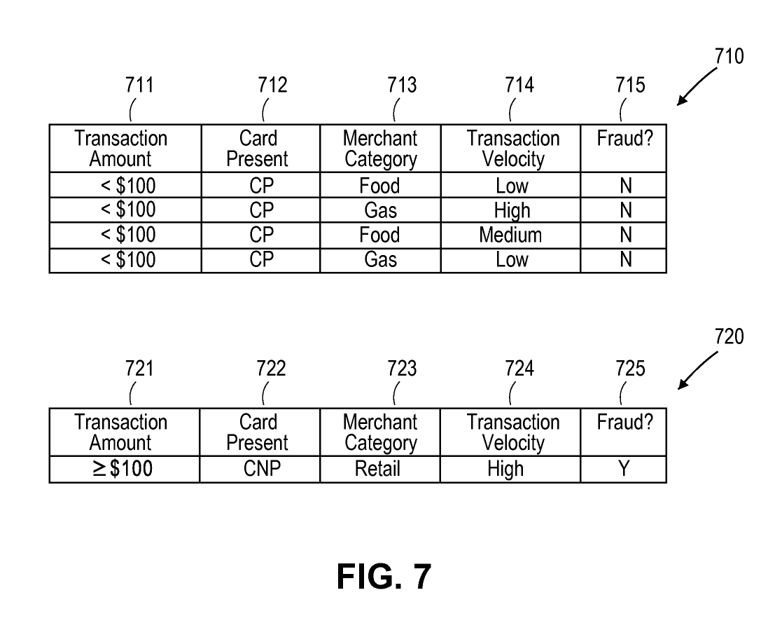

FIG. 7 shows an example of fraudulent and non-fraudulent datasets according to some embodiments of the invention. A non-fraudulent dataset is shown in table 710. A fraudulent dataset is shown in table 720. Although the datasets shown in FIG. 7 corresponds to the transaction data in FIG. 6, several fields have been omitted. For example, transaction ID 601, merchant ID 602, and issuer ID 605 are not present in FIG. 7. This may be because these fields are overly transaction-specific and therefore not predictive of fraudulent activity.

In addition, some fields in tables 710 and 720 are discretized from corresponding fields in table 600. For example, whereas the transaction amount field 603 included the dollar and cent amount of the transaction, the transaction amount fields 711 and 721 divide transactions amounts into two field values: transactions less than $100, and transactions greater than or equal to $100. In another example, merchant category fields 713 and 723 are discretized to a general merchant type from MCC field 606. For example, an MCC of 5499—corresponding to Convenience Stores and Specialty Markets—may be discretized to a merchant category field value of “Food”. An MCC of 5814—corresponding to Fast Food Restaurants—may also be discretized to a merchant category field value of “Food”. Some fields in tables 710 and 720 may not be discretized. For example, card present fields 712 and 722 may correspond to card present field 604, and transaction velocity fields 714 and 724 may correspond to transaction velocity field 607.

Returning to FIG. 4, at step 404, the rule generation computer calculates aggregate metrics. Aggregate metrics may be any metrics or statistics summarizing transaction data. In some embodiments, rule generation computer 210 may calculate the number of fraudulent transactions and non-fraudulent transactions conducted for each combination of field values. In some embodiments, rule generation computer 210 may also calculate the number of fraudulent and non-fraudulent transactions conducted.

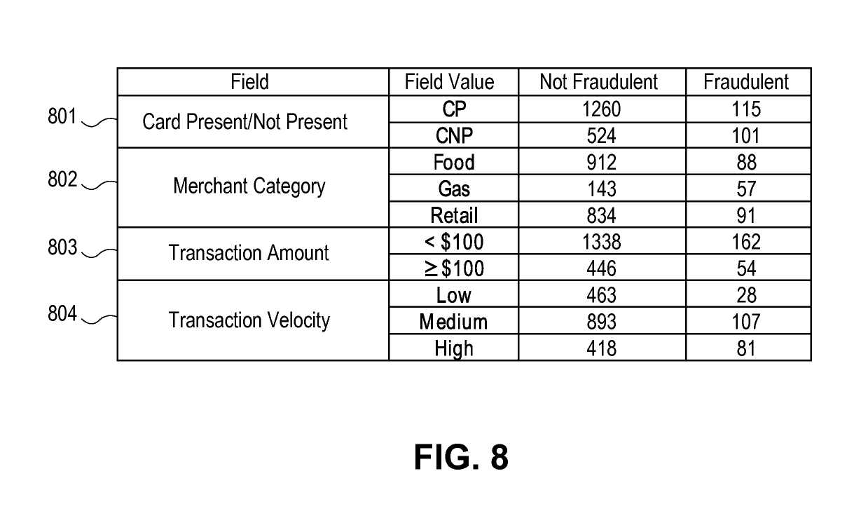

FIG. 8 shows an example of aggregate metrics according to one embodiment of the invention. In FIG. 8, the number of not fraudulent and fraudulent transactions is calculated for each field value of fields 801-804. Thus, as shown in FIG. 8, the number of non-fraudulent Card Present transactions is 1260. The number of fraudulent Card Present transactions is 115.

Returning to FIG. 4, at step 405, rule generation computer 210 identifies the field combinations of the fields in the fraudulent and non-fraudulent datasets. In various embodiments, rule generation computer 210 may identify any K-field combinations of N total fields in the datasets, where K is less than or equal to N. In some embodiments, rule generation computer 210 may identify field combinations for multiple values of K. For example, in one embodiment, if there are 9 total fields, rule generation computer may identify all 4-field combinations, 5-field combinations, and 6-field combinations.

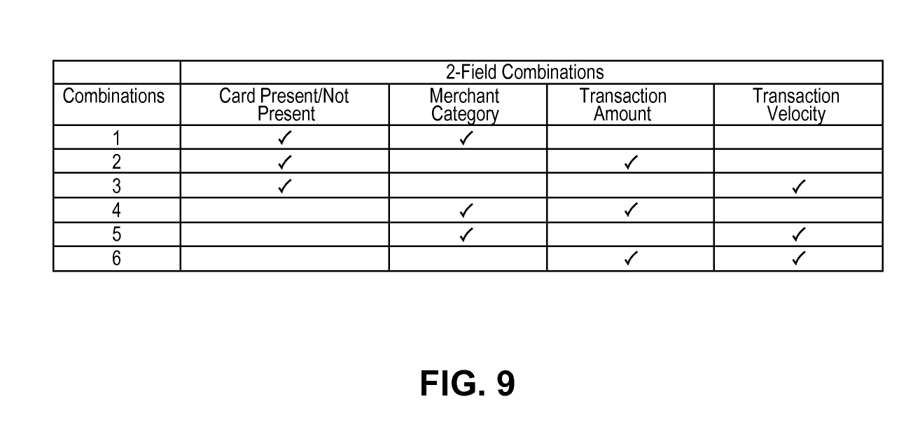

FIG. 9 shows an example of 2-field combinations according to one embodiment of the invention. In the example datasets shown in FIG. 7 and aggregate metrics shown in FIG. 8, there are four fields: “Card Present/Not Present”, “Merchant Category”, “Transaction Amount”, and “Transaction Velocity”. FIG. 9 shows all 6 2-field combinations of these fields. Each combination is indicated by a checkmark on the respective fields. For example, combination 3 would be the “Card Present/Not Present” field and the “Transaction Velocity” field.

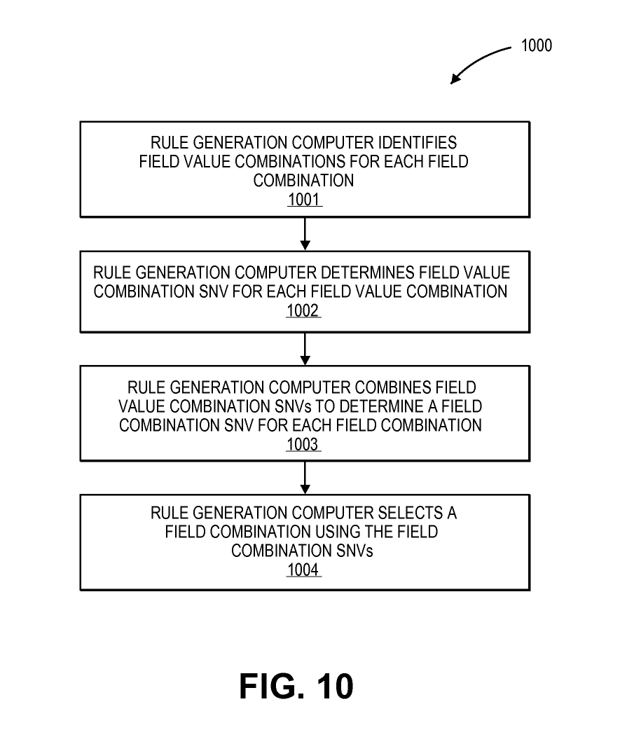

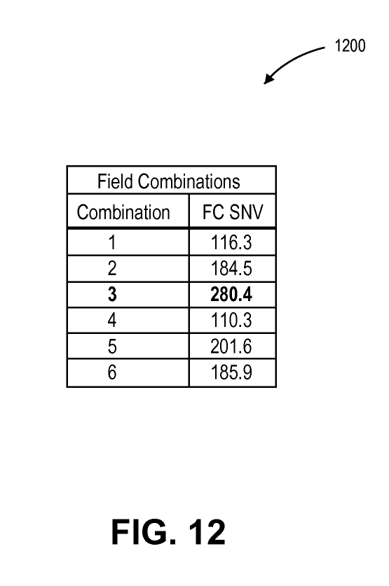

Returning to FIG. 4, at process 1000, rule generation computer 210 selects field combinations using the field combination signal-to-noise values. In the example shown in FIG. 12, of the field combinations identified in FIG. 9, combination 3 (“Card Present/Not Present” and “Transaction Amount”) is selected. The selection may be determined by any suitable method. In some embodiments, field combinations may be selected if their field combination SNV is above a threshold value. In other embodiments, only the field combinations with the highest SNVs may be selected. In yet other embodiments, all field combinations identified in step 405 may be selected. In some embodiments of the invention, the method shown in FIG. 10 may be used. For the selected field combinations, the method continues at process 1300.

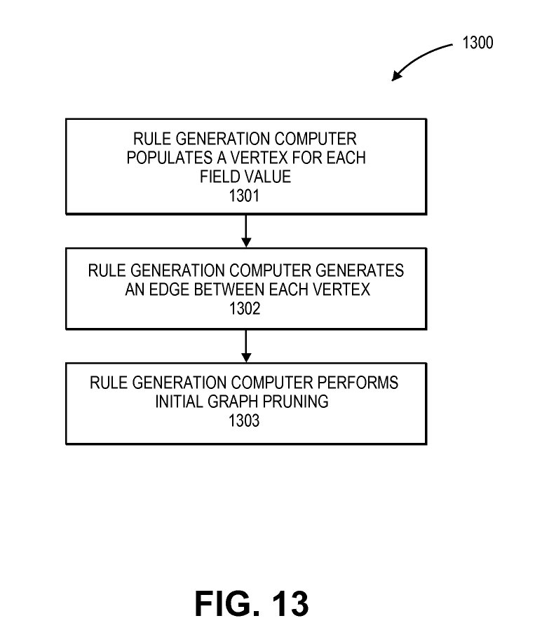

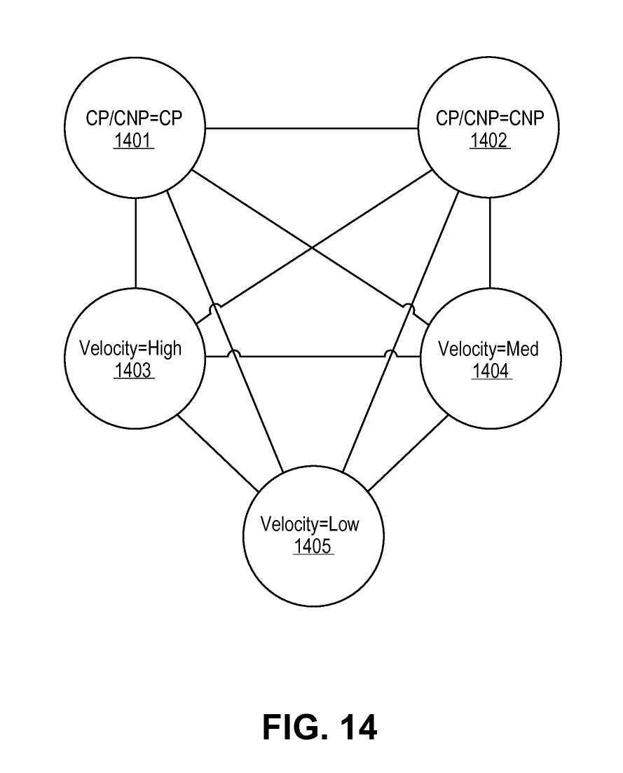

At process 1300, rule generation computer constructs a fraud rule graph for each of the selected field combinations. The vertices in the fraud rule graph may represent the field values for the fields in the field combination. The edges may represent possible conjunctions and disjunctions of the field values in a generated fraud rule. FIG. 14 shows an exemplary fraud rule graph in one embodiment of the invention. In some embodiments, such as when a fraud rule may comprise any field value, the graph may be a complete graph. In some embodiments of the invention, the method shown in FIG. 13 may be used.

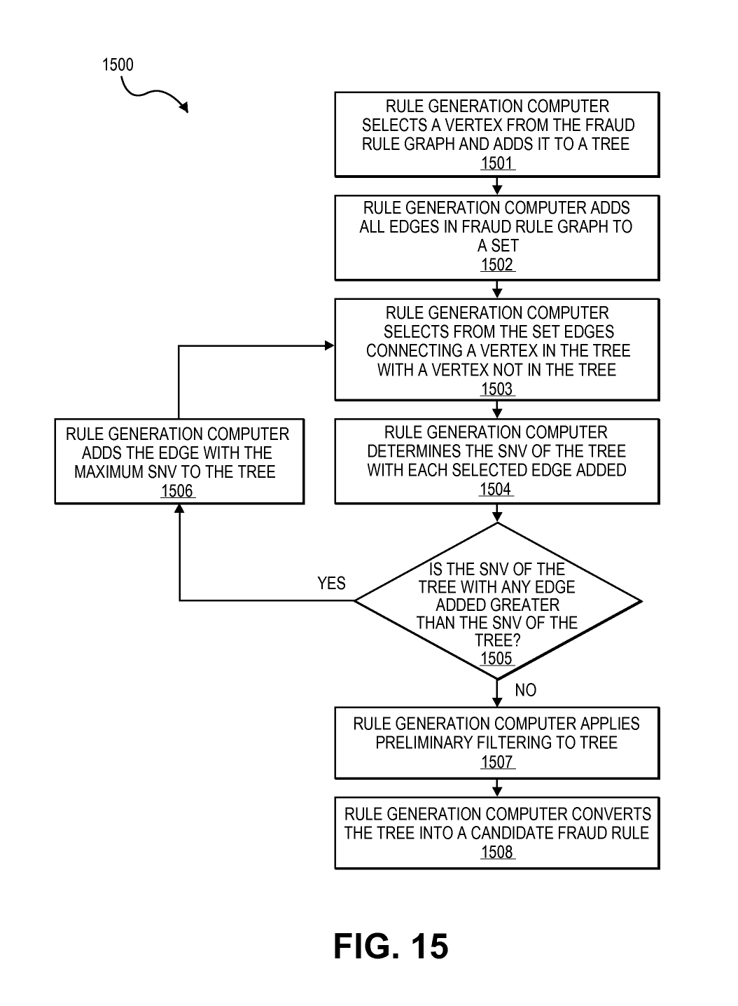

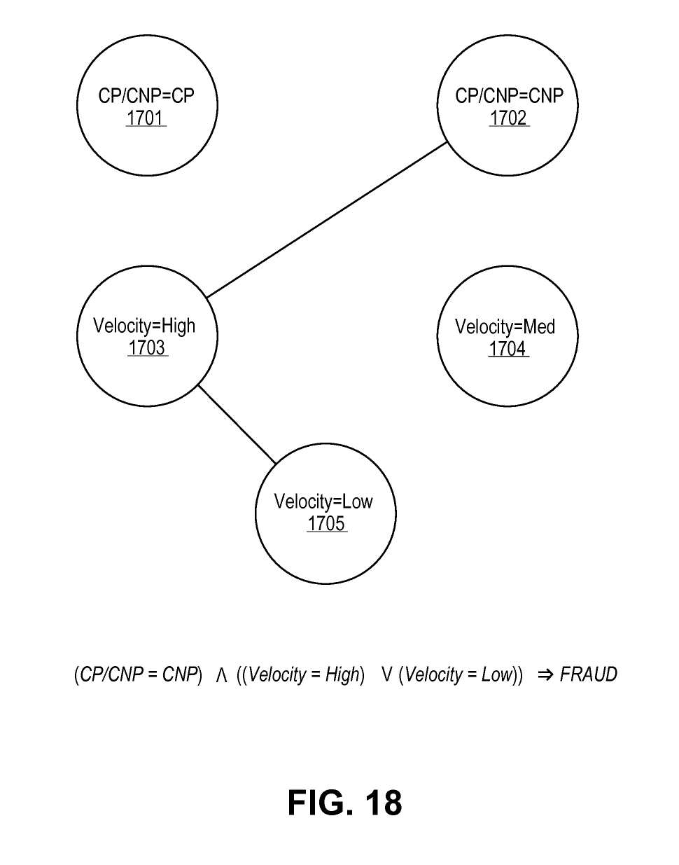

At process 1500, rule generation computer 210 generates candidate fraud rules using the fraud rule graph. In some embodiments, such as the method shown in FIG. 15, the candidate fraud rules may be generated by constructing a fraud rule tree spanning one or more vertices in the fraud rule graph. The candidate fraud rule may express a logical condition indicating a fraudulent transaction. An exemplary fraud rule tree and corresponding candidate fraud rule is shown in FIG. 18. In the shown example, the fraud rule is represented as the logical expression: (CP/CNP=CNP) AND ((Velocity=High) OR (Velocity=Low)) implies fraud. In other words, if a transaction is a Card Present transaction with either High or Low transaction velocity, then the transaction is fraudulent. Any number of fraud rule trees may be generated for each fraud rule graph, and any number of candidate fraud rules may be generated from the fraud rule trees. In some embodiments of the invention, the method shown in FIG. 15 may be used to generate candidate fraud rules using the fraud rule graph.

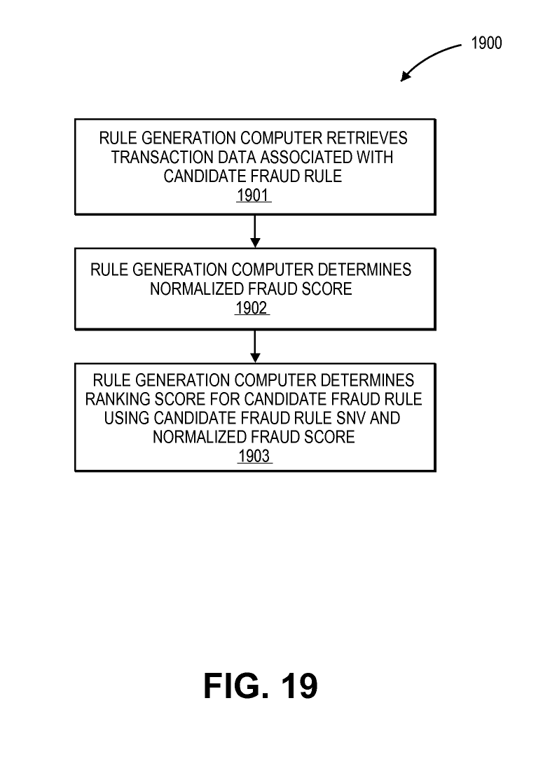

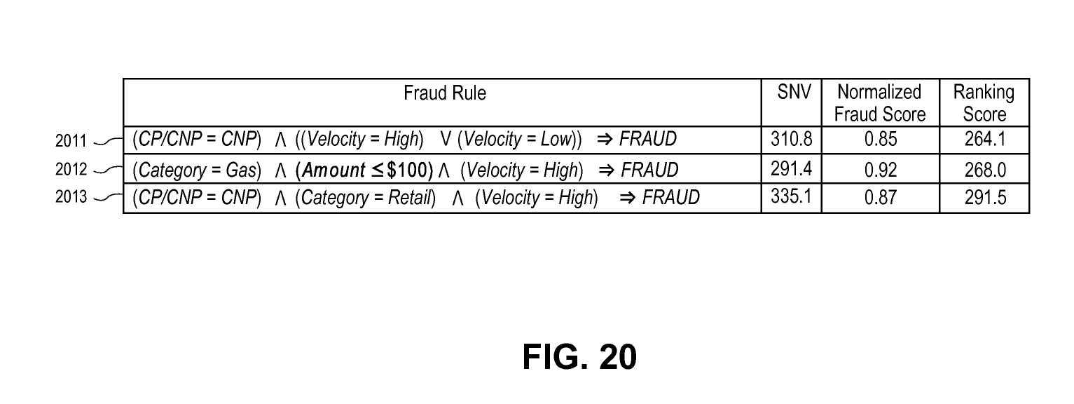

At process 2000, rule generation computer 210 determines ranking scores for the candidate fraud rules. In some embodiments of the invention, ranking scores may be determined by calculating a candidate fraud rule SNV, calculating a normalized fraud score, and determining a ranking score using the candidate fraud rule SNV and normalized fraud score. The method shown in FIG. 19 may be used to determine ranking scores in some embodiments of the invention. FIG. 20 shows exemplary candidate fraud rule SNVs, normalized fraud scores, and corresponding ranking scores. In the shown embodiment, the ranking score is the simple product of the candidate fraud rule SNV and the normalized fraud score. For example, for the first candidate fraud rule shown, candidate fraud rule SNV is 310.8 and the normalized fraud score is 0.85, so the corresponding ranking score is 264.1.

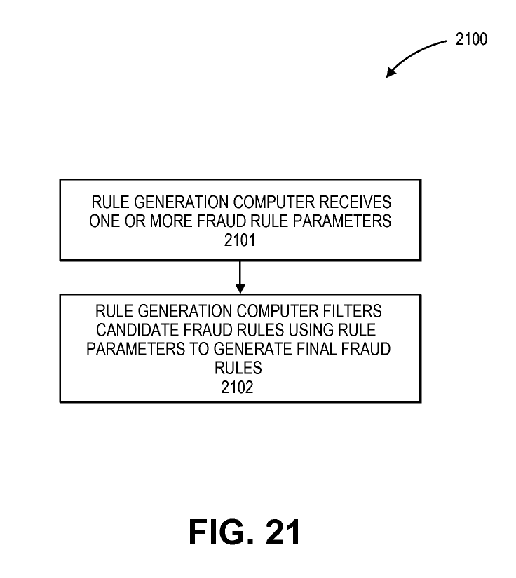

At process 2100, rule generation computer 210 filters candidate fraud rules using fraud rule parameters. The fraud rule parameters may indicate any requirements, criteria, or specifications relating to desirable fraud rules. Fraud rule parameters may be received from any suitable source, such as an issuer 108, issuer processor, or payment processing network 200. The fraud rule parameters from the different sources may be applied to the candidate fraud rules. Rules which meet the criteria specified in the fraud rule parameters may become final fraud rules. The method shown in FIG. 21 may be used to filter candidate fraud rules in some embodiments of the invention.

At step 406, rule generation computer 210 generates a rule output file. The rule output file may comprise one or more of the final fraud rules. In some embodiments of the invention, the rule output file may be an XML file and may be in a format which allows it to be easily integrated with existing fraud detection systems. In some embodiments, issuer 108 or another user may review and edit the final fraud rules.

It is noted that various steps and processed in FIG. 4 may be parallelized. In some embodiments, the various steps and processed may be divided into map and reduce phases. For example, step 404 may be performed in two phases: first, in the map phase, each transaction may be assigned a key corresponding to the field values of the transaction and whether the transaction is fraudulent, and a value of 1. Then, in the reduce phase, sum of all transactions sharing the same field values may be computed. Thus, the total number of fraudulent and non-fraudulent transactions sharing the same field values may be computed in parallel on any number of processors and/or server computers. It is noted that a person of ordinary skill would recognize how step 405, process 1000, process 1300, process 1900, process 2100, and step 406 may be parallelized in a similar manner.

FIG. 10 shows a method performed at a rule generation computer 210 for selecting field combinations. In some embodiments of the invention, the method shown in FIG. 10 may be performed after a rule generation computer 210 identifies field combinations.

At step 1001, rule generation computer 210 identifies field value combinations for each field combination. Each field value combination may represents a unique combination of field values for each field in the field combination. In some embodiments, if there are fields 1 . . . N in a field combination, with a cardinality of K₁ to K_{N} field values, respectively, than the number of field value combinations would be the product of K₁ . . . K_{N}.

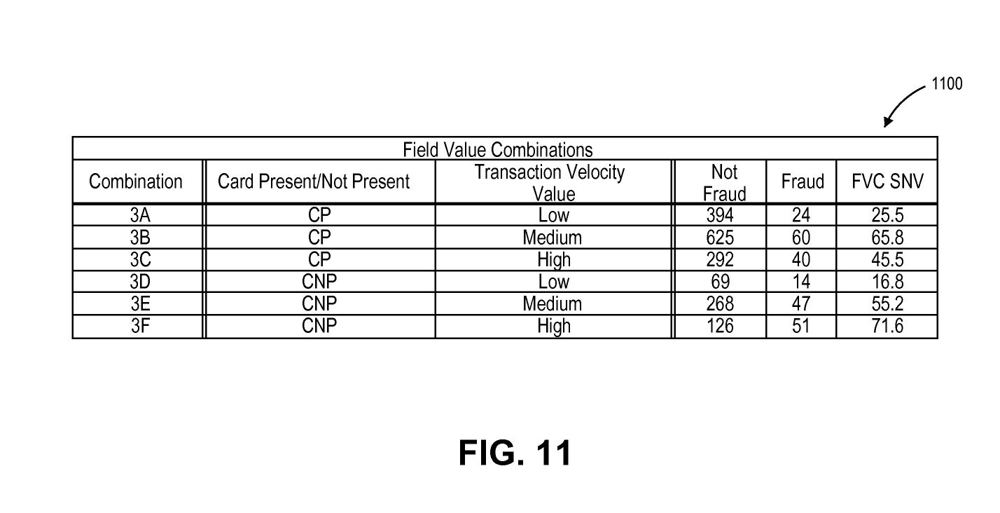

FIG. 11 illustrates exemplary field value combinations for field combination 3 as shown in FIG. 9. Field combination 3 includes the fields “Card Present/Not Present” and “Transaction Velocity”. Accordingly, the six field value combinations would be “CP” and “Low”, “CP” and “Medium”, “CP” and “High”, “CNP” and “Low”, “CNP” and “Medium”, and “CNP” and “High”, as shown in table 1100.

Returning to FIG. 10, at step 1002, rule generation computer 210 determines a field value combination SNV for each field value combination. In some embodiments, the field value combination SNV may be calculated by retrieving all transactions with field values corresponding to the field value combination. Then, the number of fraudulent and non-fraudulent retrieved transactions would be determined. Finally, the number of fraudulent and non-fraudulent transactions would be used to calculate the field value SNV. This calculation is repeated for each field value combination, for each field combination.

For example, for field value combination 3A shown in FIG. 11, Card Present transactions having a low transaction velocity would be retrieved. In the shown example, 394 of the retrieved transactions were non-fraudulent, and 24 were fraudulent. Accordingly, the field value combination SNV is calculated to be 25.5. The calculation is repeated for field value combinations 3B-3F.

At step 1003, rule generation computer 210 combines the field value combination SNVs to determine a field combination SNV for each field combination. The field value combination SNVs may be combined in any suitable manner. For example, in some embodiments, a mean or median of the field value combination SNVs may be taken. In other embodiments, the sum or product of the field value combination SNVs may be calculated.

FIG. 12 shows an exemplary table comprising field combination SNVs for field combinations 1-6 corresponding to those identified in FIG. 9. In the shown embodiment, the field combination SNVs are calculated by the sum of all field value combination SNVs for the field combination. For example, the sum of field value combinations 3A-3F shown in table 1100 is 280.4, which is shown as the field combination SNV for field combination 3 in table 1200.

At step 1004, rule generation computer selects a field combination using the field combination SNVs. The field combination may be selected using any suitable criteria. In the example shown in FIG. 11, the field combination with the highest field combination SNV is selected.

In some embodiments of the invention, multiple field combinations may be selected. For example, all field combinations above a threshold field combination SNV may be selected. In other embodiments, the method shown in FIG. 10 may not be performed, and all field combinations may be selected. In some embodiments, the field combinations may be the final output. In other embodiments, a fraud rule graph may be generated from the field combinations. One method for constructing a fraud rule graph is shown in FIG. 13.

FIG. 13 shows a method of constructing a fraud rule graph for some embodiments of the invention. A fraud rule graph may be used to represent the universe of possible fraud rules in a graph data structure. In some embodiments, the method shown in FIG. 13 may be performed after selecting one or more field combinations. Alternately, in other embodiments, the method in FIG. 13 may be performed for all field combinations, for any size of field combination. For example, for a dataset with 9 fields, the method may be performed for any number of 1-field combinations, 2-field combinations, 3-field combinations, etc.

At step 1301, rule generation computer 210 populates a vertex in the fraud rule graph for each field value. In embodiments wherein the field values are derived from a field combination, the field values may comprise the field values for the fields in the field combination. In some embodiments, if there are fields 1 . . . N in a field combination, with a cardinality of K₁ to K_{N} field values, respectively, than the number total number of vertices would be the sum of K₁ . . . K_{N}.

At step 1302, rule generation computer 210 generates an edge between each vertex in the fraud rule graph. In some embodiments, an edge may be omitted between two vertices if fraud rules should not be generated containing field values corresponding to the two vertices.

FIG. 14 shows an exemplary fraud rule graph with vertices and edges populated in accordance with the method shown in FIG. 13. The field combination used to generate the fraud rule graph is field combination 3 from FIGS. 9 and 12. The corresponding field values, “Card Present” and “Card Not Present” for field “Card Present/Not Present”, and “Low”, “Medium”, and “High” for “Transaction Velocity” are populated as vertices 1401-1405, respectively. The graph is complete—each edge is connected to every other edge.

FIG. 15 shows a method for generating a candidate fraud rule using a fraud rule tree according to some embodiments of the invention. In some embodiments, the method described in FIG. 15 may be performed for each vertex in each fraud rule graph.

At step 1501, rule generation computer 210 selects a vertex from a fraud rule graph and adds it to a fraud rule tree. For example, a vertex corresponding to the field value “Card Not Present” may be selected.

At step 1502, rule generation computer 210 adds all edges in the fraud rule graph to a set.

At step 1503, rule generation computer 210 selects from the set edges connecting a vertex in the fraud rule tree with a vertex not in the fraud rule tree. For example, if there is a single vertex A in the fraud rule tree, then each edge adjacent to vertex A would be selected. In another example, if there are three vertices B, C, and D in the fraud rule tree, then any edge connecting one of the three vertices B, C, or D to a vertex other than B, C, or D would be selected.

At step 1504, rule generation computer 210 determines the fraud rule tree SNV for the tree if each selected edge were to be added. The fraud rule tree SNV may be computed by any suitable method. For example, in one embodiment, the fraud rule tree may be used to derive a fraud rule. The number of fraudulent and non-fraudulent transactions triggered by the fraud rule may be determined. Then, the fraud rule tree SNV may be calculated using the determination. In another embodiment, the fraud rule tree SNV may be a function of the length of a candidate fraud rule generated from the tree, so that longer and more difficult to understand rules are given a smaller score.

At conditional step 1505, each of the determined fraud rule tree SNVs is compared to the current fraud rule tree SNV. If any of the determined fraud rule tree SNVs is greater than the current fraud rule tree SNV, the method proceeds to step 1506. Otherwise, the method proceeds to step 1507.

At step 1506, rule generation computer 210 adds the edge maximum determined fraud rule tree SNV to the fraud rule tree. In one example, the current fraud rule tree may comprise edges E1(V1, V2) and E2(V1, V3), and have a fraud rule tree SNV of 50. If the fraud rule tree SNV of the current tree with edge E3(V3, V4) added has a fraud rule tree SNV of 100, and no other edge when added to the current fraud rule tree yields a greater SNV, then edge E3 would be added to the fraud rule tree, so that the current fraud rule tree would comprise edges E1, E2, and E3.

At step 1508, rule generation computer 210 converts the fraud rule tree into a candidate fraud rule. In some embodiments of the invention, each vertex in the tree may indicate an triggering field value for the corresponding field in the fraud rule. For example, for a tree comprising edges E1 (“CP/CNP=CP”, “Velocity=High”), E2 (“CP/CNP=CP”, “Amount=<$100”), the corresponding fraud rule would trigger on Card Present transactions with high transaction velocity, and with a transaction amount less than $100. In another example, for a tree comprising edges E1 (“CP/CNP=CP”, “Velocity=High”), E2 (“CP/CNP=CNP”, “CP/CNP=CP”), the corresponding fraud rule would trigger on either Card Present or Card Not Present transactions with a high transaction velocity. Thus, assuming that a transaction must be either Card Present or Card Not Present, the rule in the example would effectively trigger on high transaction velocity.

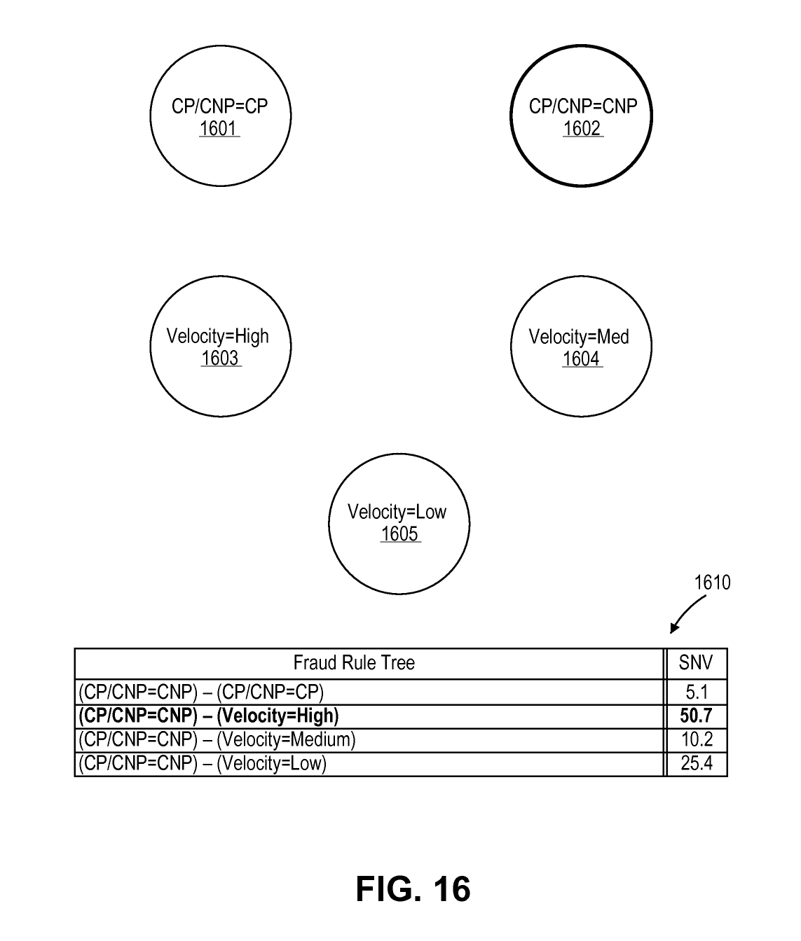

The method in FIG. 15 may be applied to field combination 3 shown in FIGS. 9 and 12 and the corresponding fraud rule graph as shown in FIG. 14. At step 1501, vertex 1402, corresponding to a field value of Card Not Present, is selected from the fraud rule graph and added to a tree. The resulting fraud rule tree, comprising only the vertex 1602, is shown in FIG. 16. At step 1502, all 20 edges in the fraud rule graph are added to a set. At step 1503, edges connecting vertices in the tree with vertices not in the tree are selected from the set. Since the tree comprises only vertex 1602, four edges are selected: an edge between vertex 1602 and vertex 1601, an edge between vertex 1602 and 1603, an edge between vertex 1602 and 1604, and an edge between vertex 1602 and 1605. At step 1504, the fraud rule tree SNV is determined for each edge. Table 1610 shows the determined fraud rule tree SNVs. Assuming the current fraud rule tree SNV is less than 50.7, the conditional step 1505 evaluates to true, so accordingly step 1506 is performed.

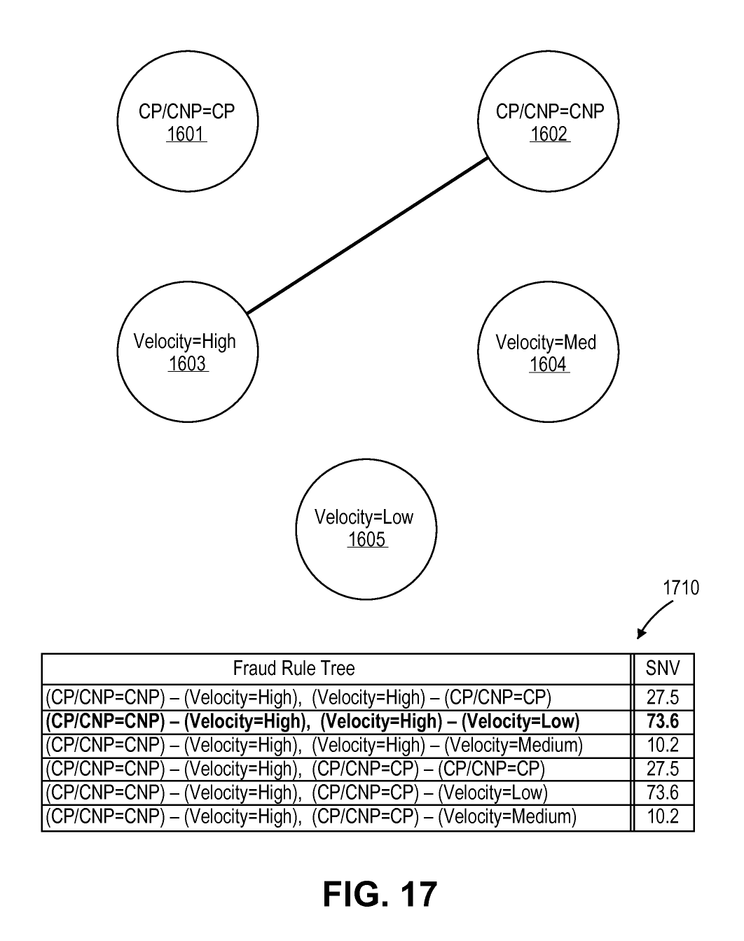

At step 1506, the rule generation computer 210 adds the edge with the maximum SNV, in this case the edge between vertices 1602 and 1603, to the fraud rule tree. Accordingly, the new fraud rule tree is shown in FIG. 17. At step 1503, edges connecting the vertices in the tree and vertices not in tree are again selected. Six such edges are selected, as shown in table 1710. At step 1504, the fraud rule tree SNV is determined for each of these edges. The corresponding SNV is also shown in table 1710. Since the current fraud rule tree SNV is 50.7 and the highest fraud rule tree SNV determined is 73.6, the conditional step 1505 evaluates to true. Accordingly step 1506 is repeated.

In some embodiments of the invention, rule generation computer 210 may adjust a fraud rule tree SNV based on the degree of overlap between transactions triggering previously generated fraud rules and transactions triggering a candidate fraud rule corresponding to the fraud rule tree. For example, if the set of transactions triggered by a candidate fraud rule is a subset of the transactions triggered by previously generated fraud rules, then the candidate fraud rule may be considered less useful, because it would not detect fraud on many additional transactions as compared to the existing set of fraud rules. Accordingly, the fraud rule tree SNV may be decreased. In contrast, if the set of transactions that trigger the candidate fraud rule is disjoint from the set of transactions triggering previously generated fraud rules, then the candidate fraud rule may be considered more useful, because it detects fraud on transactions which previous rules would not detect. Accordingly, the fraud rule tree SNV may be increased.

At step 1506, the rule generation computer adds the edge with the maximum SNV, in this case the edge between vertices 1603 and 1605, to the fraud rule tree. Accordingly, the new fraud rule tree is shown in FIG. 18. At step 1503, edges connecting the vertices in the tree and vertices not in tree are again selected. Six such edges are selected. At step 1504, the fraud rule tree SNV is determined for each of these edges. However, in the shown example the current fraud rule tree SNV is 73.6 and no determined fraud rule tree SNV is higher, so the conditional step 1505 evaluates to false. Accordingly the method moves to step 1507.

At step 1507, rule generation computer 210 applies preliminary filtering to the fraud rule tree. Preliminary filtering may be any filtering which is applied to fraud rule tree before it is converted into a candidate fraud rule. For example, in some embodiments, rule generation computer 210 may filter fraud rule trees with a fraud rule tree SNV less than a threshold value. If the tree is filtered, the process ends. Otherwise, step 1508 is performed.

At step 1508, a candidate fraud rule is generated from the fraud tree. Since the fraud tree comprises the vertices CP/CNP=CP, Velocity=High, and Velocity=Low, the corresponding candidate fraud rule triggers on Card Not Present transactions with either high or low transaction velocity (but not medium transaction velocity). In other words, the method has determined that a Card Not Present transaction with an irregular transaction velocity is an indicator of fraud.

FIG. 19 shows a method for determining ranking scores for candidate fraud rules. Typically, the method of FIG. 19 may be performed after generating candidate fraud rules.

At step 1901, rule generation computer 210 retrieves transaction data associated with a candidate fraud rule. In some embodiments of the invention, the transaction data may be transactions which are triggered by the candidate fraud rule. For example, if a candidate fraud rule triggers on Card Not Present transactions with high transaction velocity, the transaction data may be the set of Card Present high velocity transactions.

At step 1902, rule generation computer 210 determines a normalized fraud score. The normalized fraud score may be determined using the retrieved transaction data. In some embodiments, the normalized fraud score provides an indication of the likelihood of fraud in the retrieved transactions. For example, the normalized fraud score may be the average fraud score for the retrieved transactions. In some embodiments, the normalized fraud score may be between 0 and 1 and may indicate the percentage likelihood that one of the retrieved transactions is fraudulent.

At step 1903, rule generation computer 210 determines a ranking score for the candidate fraud rule using the normalized fraud score. In some embodiments, the ranking score may be the simple product of the candidate fraud rule SNV and the normalized fraud score. In other embodiments, a different formula or method may be used to calculate the ranking score.

FIG. 20 illustrates the application of the method of FIG. 19 to an exemplary set of candidate fraud rules in one embodiment of the invention. In FIG. 20, table 2010 shows three candidate fraud rules 2011-2013. Each of the candidate fraud rules has an associated candidate fraud rule SNV. In addition, each of the candidate fraud rules has an associated normalized fraud score. The ranking score shown is the product of the candidate fraud rule SNV and the normalized fraud score.

FIG. 21 shows a method for filtering candidate fraud rules using fraud rule parameters to generate final fraud rules according to one embodiment of the invention.

At step 2101, rule generation computer 210 receives one or more fraud rule parameters. The fraud rule parameters may indicate any requirements, criteria, or specifications relating to desirable fraud rules. Fraud rule parameters may be received from any suitable source, such as an issuer 108, issuer processor, or payment processing network 200. The fraud rule parameters from the different sources may be applied to the candidate fraud rules. Rules which meet the criteria specified in the fraud rule parameters may become final fraud rules.

In some embodiments of the invention, fraud rule parameters may specify a desired ranking or ranking score for the generated fraud rules. For example, payment processing network 200 may indicate that only candidate fraud rules with a ranking score higher than 200 may be used to generate final fraud rules. In another example, issuer 108 may specify that only the top 5 candidate fraud rules should may be used to generate final fraud rules.

In some embodiments of the invention, fraud rule parameters may specify undesirable characteristics of the final fraud rules. In one example, an issuer 108 may not desire fraud rules for transactions with a transaction amount over $1000. For example, the issuer 108 may instead handle fraudulent activity on such transactions through human review. Rule generation computer 210 may evaluate a fraud rule parameter that final fraud rules must relate only to transactions with a transaction amount less than or equal to $1000.

In some embodiments of the invention, fraud rule parameters may specify a desired time-invariance of the final fraud rules. For example, the issuer 108 may desire that the generated final fraud rules are generalizable to multiple time periods. Accordingly, rule generation computer 210 may evaluate a fraud rule SNV or other metrics on the candidate fraud rules for transactions over varying time periods. Final fraud rules may only be generated from candidate fraud rules meeting a defined threshold or other criteria.

In some embodiments of the invention, fraud rule parameters may specify a desired human readability of the final fraud rules. The human readability may be determined, in some embodiments, by the number of terms in the candidate fraud rule. For example, a fraud rule having 9 terms may be considered less readable than a fraud rule having 3 terms. Accordingly, rule generation computer 210 may evaluate the candidate fraud rules by the number of terms in the candidate fraud rule or any other suitable metric.

In various embodiments, any of the above fraud rule parameters may be combined and/or weighted, so that each may contribute to an ultimate determination of the final fraud rules generated from a set of candidate fraud rules.

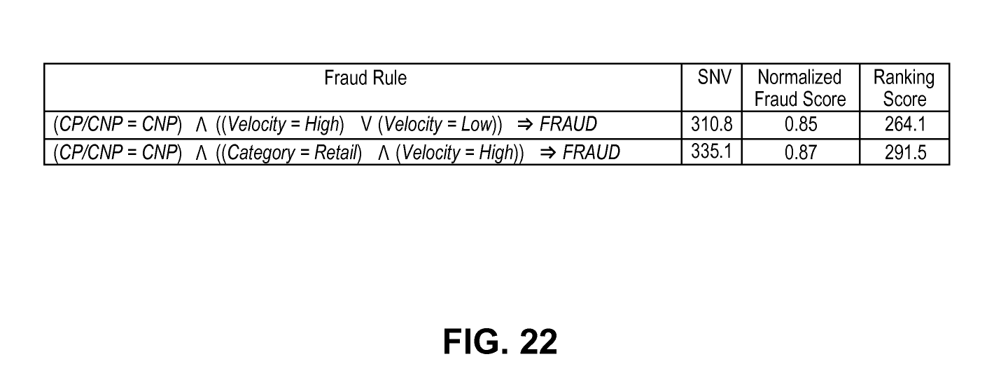

FIG. 22 illustrates an exemplary set of final fraud rules in one embodiment of the invention. The shown set of final fraud rules is similar to the set of candidate fraud rules shown in FIG. 20, except that rule 2012 is missing. This may be, for example, because rule 2012 did not meet some fraud rule parameters.

III. Exemplary Fraud Rule Evaluation Methods

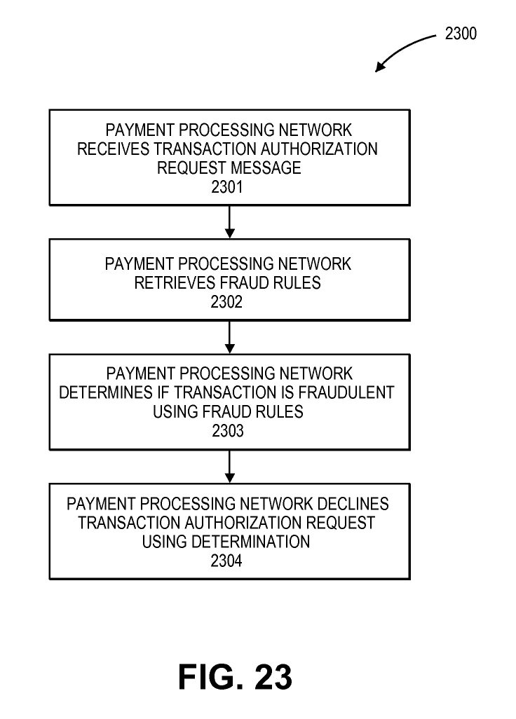

FIG. 23 shows a method of evaluating fraud rules according to one embodiment of the invention.

At step 2301, payment processing network 200 receives a transaction authorization request message. The transaction authorization request message may be sent, for example, during a payment transaction as described in FIG. 1.

At step 2302, payment processing network 200 retrieves fraud rules. The fraud rules may be final fraud rules generated using the method of FIG. 4, or fraud rules from any other source.

At step 2302, payment processing network 200 determines if the transaction is fraudulent using the fraud rules. For example, in some embodiments, the payment processing network 200 may evaluate each fraud rule against the field values for the transaction authorization request. If any evaluated rule is triggered, then the transaction may be determined as fraudulent.

At step 2304, payment processing network 200 declines a transaction authorization request using the determination. In various embodiments of the invention, other treatments may be performed based on the determination. For example, in some cases, a code may be returned indicating that the consumer should call the issuer. In some cases, a code may be returned indicating the authorization will be manually reviewed. In yet other embodiments, the transaction may be authorized but logged for later review.

In some embodiments, the treatment may be determined using the fraud rule that was triggered. For example, a fraud rule with a high fraud rule SNV may cause a transaction to be declined, whereas a fraud rule with low fraud rule SNV may cause a transaction to be authorized, but flagged for later review.

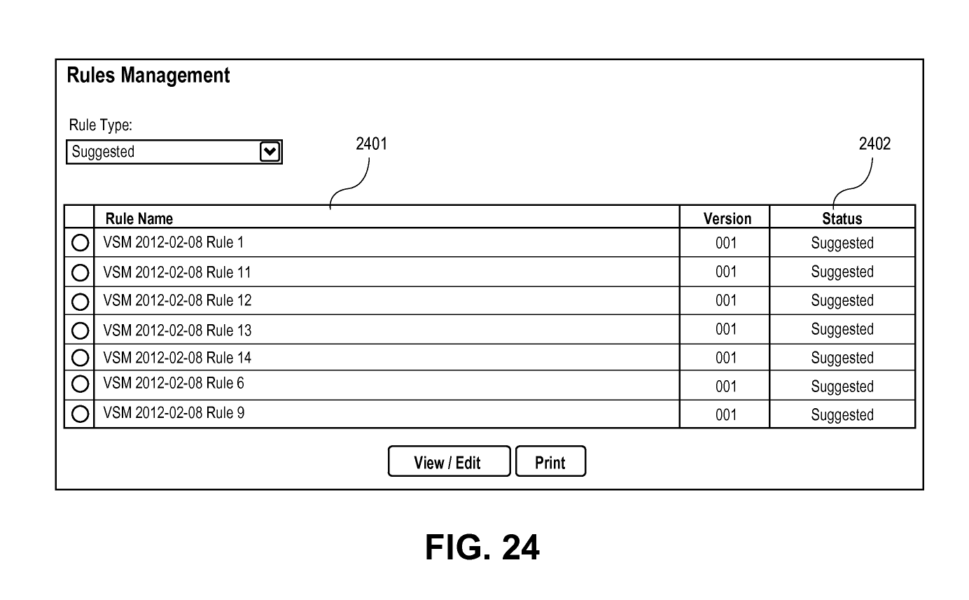

FIG. 24 shows an exemplary user interface displaying generated fraud rules. The user interface may comprise a listing of the generated rules 2401, and an indication whether the fraud rules were suggested (i.e., automatically generated), or whether the user manually defined them 2401. The user interface may also include links to view and edit the fraud rules.

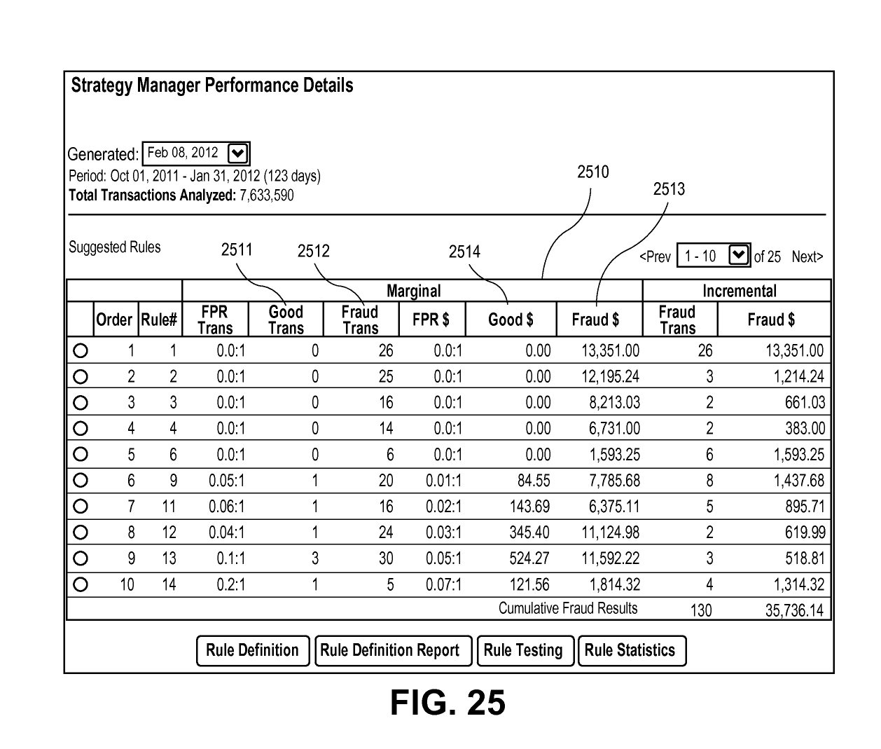

FIG. 25 shows an exemplary user interface displaying statistics regarding the generated fraud rules. The user interface may comprise a table 2510 listing rule numbers and a rank ordering of the rules. The table 2510 may comprise multiple columns, such as a number of times the fraud rule triggered on non-fraudulent transactions 2512, a transaction amount value for the good transactions 2511, a total transaction amount value for the fraudulent transactions triggering the fraud rule 2514, a total transaction amount value for the non-fraudulent transactions triggering the fraud rule 2513, etc. In addition, the user may be presented with rule reports, rule statistics, or other information.

It is noted that other embodiments of the invention may differ from the one illustrated in FIG. 23. For example, in some embodiments, the method may be performed by a party other than payment processing network 200.

IV. Exemplary Computer Apparatuses

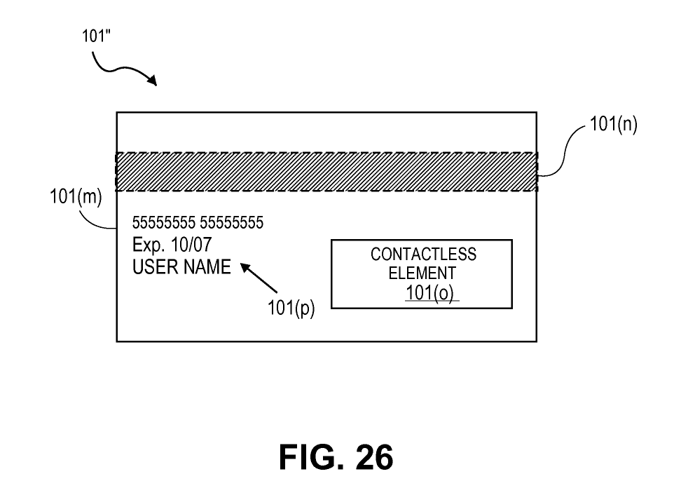

FIG. 26 shows an example of a payment device 101″ in the form of a card. As shown, the payment device 101″ comprises a plastic substrate 101(m). In some embodiments, a contactless element 101(o) for interfacing with an access device 102 may be present on, or embedded within, the plastic substrate 101(m). Consumer information 101(p) such as an account number, expiration date, and/or a user name may be printed or embossed on the card. A magnetic stripe 101(n) may also be on the plastic substrate 101(m). In some embodiments, the payment device 101″ may comprise a microprocessor and/or memory chips with user data stored in them.

As noted above and shown in FIG. 26, the payment device 101″ may include both a magnetic stripe 101(n) and a contactless element 101(o). In some embodiments, both the magnetic stripe 101(n) and the contactless element 101(o) may be in the payment device 101″. In some embodiments, either the magnetic stripe 101(n) or the contactless element 101(o) may be present in the payment device 101″.

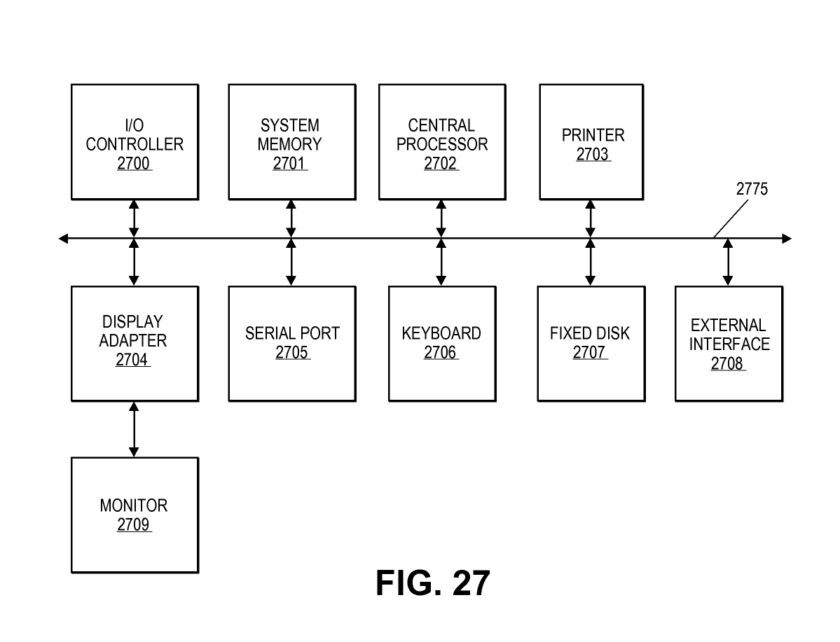

FIG. 27 is a high level block diagram of a computer system that may be used to implement any of the entities or components described above. The subsystems shown in FIG. 27 are interconnected via a system bus 2775. Additional subsystems include a printer 2703, keyboard 2706, fixed disk 2707, and monitor 2709, which is coupled to display adapter 2704. Peripherals and input/output (I/O) devices, which couple to I/O controller 2700, can be connected to the computer system by any number of means known in the art, such as a serial port. For example, serial port 2705 or external interface 2708 can be used to connect the computer apparatus to a wide area network such as the Internet, a mouse input device, or a scanner. The interconnection via system bus 2775 allows the central processor 2702 to communicate with each subsystem and to control the execution of instructions from system memory 2701 or the fixed disk 2707, as well as the exchange of information between subsystems. The system memory 2701 and/or the fixed disk may embody a computer-readable medium.

V. Additional Embodiments

It is noted that other embodiments of the invention are possible. For example, some embodiments of the invention may relate to generating rules associated with other behavior. For example, some embodiments of the invention may relate to generating rules for likely consumer behavior or consumer preferences, such as for a coupon or offers marketing application. In such embodiments, a rule may be used to determine, for example, whether a consumer may be interested in a product offer or coupon. A signal-to-noise value may be determined based on the ratio of previous users which responded to an offer to those that did not respond to the offer. Fields may include user information, such as demographic information or personal information.

Yet other embodiments of the invention may relate to generation fraud rules at a merchant or merchant processor. In some embodiments, the signal-to-noise ratio may be determined using a number of fraudulent and non-fraudulent transactions. The fields may include transaction data available to a merchant. Rule parameters may be defined by the merchant or merchant processor.

Yet other embodiments of the invention may relate to detection of computer security attacks. For example, some embodiments of the invention, a rule may be generated and used to determine whether the security of a computer network or system has been compromised. Fields may include data regarding the computer network or system, such as anomalous or suspicious activity, including network activity, running processes, and recently modified files. A signal-to-noise ratio may be determined using a number of confirmed attacks to a number of confirmed non-attacks.

It is noted that the systems and methods described above may be used generally for any service involving forming predictive rules using past data fields and field values.

A further embodiment of the invention discloses a computer-implemented method. The method comprises receiving, by a processor, transaction data comprising a plurality of fields, wherein each field is associated with one or more field values, identifying one or more field combinations using the fields, determining a field combination signal-to-noise value for one of the identified field combinations, wherein the field combination signal-to-noise value is determined using one or more field value combination signal-to-noise values, selecting a field combination, constructing a fraud rule graph, wherein vertices in the fraud rule graph correspond to a plurality of the one or more field values associated with the selected field combination, generating a tree, wherein generating the tree comprises selecting an edge from a set of edges connecting a vertex in the tree with a vertex not in the tree, and adding the edge to the tree if the edge has a maximum signal-to-noise value of all edges in the set of edges, and converting the tree into a candidate fraud rule.

A further embodiment of the invention discloses a server computer. The server computer comprises a processor and a non-transitory computer-readable storage medium, comprising code executable by the processor for implementing a method comprising receiving, by the processor, transaction data comprising a plurality of fields, wherein each field is associated with one or more field values, identifying one or more field combinations using the fields, determining a field combination signal-to-noise value for one of the identified field combinations, wherein the field combination signal-to-noise value is determined using one or more field value combination signal-to-noise values, selecting a field combination, constructing a fraud rule graph, wherein vertices in the fraud rule graph correspond to a plurality of the one or more field values associated with the selected field combination, generating a tree, wherein generating the tree comprises selecting an edge from a set of edges connecting a vertex in the tree with a vertex not in the tree, and adding the edge to the tree if the edge has a maximum signal-to-noise value of all edges in the set of edges, and converting the tree into a candidate fraud rule.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A computer-implemented method comprising:
receiving, by a processor, transaction data comprising a plurality of fields, wherein each field is associated with one or more field values;
identifying a plurality of field combinations using the plurality of fields, wherein each field combination is associated with one or more field value combinations;
determining a plurality of field combination signal-to-noise values for the identified field combinations, wherein each field combination signal-to-noise value in the plurality of field combination signal-to-noise values is determined using one or more field value combination signal-to-noise values; and
selecting a field combination based on the determined field combination signal-to-noise values, wherein the field combination is used to generate a rule.

2. The method of claim 1, wherein the rule is a fraud rule.

3. The method of claim 2, wherein a number of fraudulent transactions and a number of non-fraudulent transactions are associated with the one or more field value combinations.

4. The method of claim 3, wherein each field value combination signal-to-noise value in the one or more field value combination signal-to-noise values is proportional to a ratio of fraudulent transactions to non-fraudulent transactions associated with a field value combination, and proportional to a number of transactions associated with the field value combination.

5. The method of claim 1, further comprising constructing a rule graph, wherein each vertex in the rule graph corresponds to a field value in the one or more field values, and wherein the rule graph is used to generate a rule.

6. A server computer, comprising:
a processor; and
a non-transitory computer-readable storage medium, comprising code executable by the processor for implementing a method comprising:
receiving, by the processor, transaction data comprising a plurality of fields, wherein each field is associated with one or more field values;
identifying a plurality of field combinations using the plurality of fields, wherein each field combination is associated with one or more field value combinations;
determining a plurality of field combination signal-to-noise values for the identified field combinations, wherein each field combination signal-to-noise value in the plurality of field combination signal-to-noise values is determined using one or more field value combination signal-to-noise values; and
selecting a field combination based on the determined field combination signal-to-noise values, wherein the field combination is used to generate a rule.

7. The computer of claim 6, wherein the rule is a fraud rule, and wherein a number of fraudulent transactions and a number of non-fraudulent transactions are associated with the one or more field value combinations.

8. The computer of claim 7, wherein each field value signal-to-noise value in the one or more field value combination signal-to-noise values is proportional to a ratio of fraudulent transactions to non-fraudulent transactions associated with a field value combination, and also proportional to a number of transactions associated with the field value combination.

9. The computer of claim 6, wherein the method further comprises constructing a rule graph, wherein each vertex in the rule graph corresponds to a field value in the one or more field values, and wherein the rule graph is used to generate a rule.

10. A computer-implemented method comprising:
receiving, by a processor, transaction data comprising a plurality of fields, wherein each field is associated with one or more field values;
constructing a rule graph, wherein each vertex in the rule graph corresponds to a field value in the one or more field values;
generating a tree, wherein generating the tree comprises:
selecting an edge from a set of edges connecting a vertex in the tree with a vertex not in the tree; and
adding the edge to the tree if the edge is associated with a maximum signal-to-noise value of all edges in the set of edges; and
converting the tree into a candidate rule.

11. The method of claim 10, wherein the candidate rule is a candidate fraud rule.

12. The method of claim 10, wherein the method further comprises:
determining a ranking score for the candidate rule, wherein the ranking score is calculated using transaction data associated with the candidate rule.

13. The method of claim 10, further comprising:
receiving rule parameters; and
filtering candidate rules using the rule parameters to generate final rules.

14. The method of claim 13, further comprising: generating an output file comprising the final rules.

15. The method of claim 10, wherein the plurality of the one or more field values is determined using a method comprising: identifying one or more field combinations using the plurality of fields; determining a field combination signal-to-noise value for the identified field combinations; and selecting a field combination.

16. A server computer, comprising:
a processor; and
a non-transitory computer-readable storage medium, comprising code executable by the processor for implementing a method comprising:
receiving, by the processor, transaction data comprising a plurality of fields, wherein each field is associated with one or more field values;
constructing a rule graph, wherein each vertex in the rule graph corresponds a field value in the one or more field values;
generating a tree, wherein generating the tree comprises:
selecting an edge from a set of edges connecting a vertex in the tree with a vertex not in the tree; and
adding the edge to the tree if the edge is associated with a maximum signal-to-noise value of all edges in the set of edges; and
converting the tree into a candidate rule.

17. The computer of claim 16, wherein the method further comprises: determining a ranking score for the candidate rule, wherein the ranking score is calculated using transaction data associated with the candidate rule.

18. The computer of claim 16, wherein the method further comprises:
receiving rule parameters; and
filtering candidate rules using the rule parameters to generate final rules.

19. The computer of claim 18, wherein the method further comprises: generating an output file comprising the final rules.

20. The computer of claim 16, wherein the plurality of the one or more field values is determined using a method comprising: identifying one or more field combinations using the plurality of fields; determining a field combination signal-to-noise value for the identified field combinations; and selecting a field combination.
